(19) United States
(12) Patent Application Publication
(10) Pub. No.: US 2006/0242194 A1
(43) Pub. Date: Oct. 26, 2006

(54) Systems and methods for modeling and manipulating a table-driven business application in an object-oriented environment

(76) Inventors: Igor Tsyganskiy, Palo Alto, CA (US); Vitaliy Stulski, San Mateo, CA (US); Eugene Satsuta, Saratoga, CA (US); Luiz Scheinkman, Sunnyvale, CA (US); Dmitri Liakh, Foster City, CA (US)

Correspondence Address: Finnegan, Henderson, Farabow,;Garrett & Dunner, L.L.P., 901 New York Avenue, N.W., Washington, DC, 20001-4413, US

(21) Appl. No.: 11/111,794

(22) Filed: Apr. 22, 2005

(51) Int. Cl. G06F 7/00

(52) U.S. Cl. 707/103 R

(57) ABSTRACT

Systems, methods, and computer program products consistent with the invention analyze a business application's data, operations, and relationships and create a corresponding object oriented programming (OOP) model of the application, comprising OOP objects, functions, and operators corresponding to the business application's entities. Each OOP entity in the model entity accurately represents the data, relationships, and rules associated with the corresponding business entity. Once converted to an OOP model, standard OOP tools may be used to understand, manipulate, design, redesign, analyze, optimize, and modify the business application model independent of the native business application system. Entities from the OOP model may be converted into corresponding business application entities having the same properties and installed in the native business application system.

### BACKGROUND

I. Relevant Field

The present inventions generally relate to business application software. More particularly, the inventions relate to systems, methods and computer readable media for object-oriented programming (OOP) modeling of business applications and the use of an OOP model to create, improve, and maintain a business application.

II. Background Information

One drawback with legacy business application systems stems from the fact that the business data and rules are often contained in data fields and structures in separate physical database fields and tables, with little user-friendly representation of organization, structure, or relationships. Table-driven systems are difficult to work with. For example, a business object may be defined across ten or more different database tables that are not easily accessed, displayed, or understood together.

Furthermore, as shown in the example of FIG. 3, a table-driven business application typically stores its configuration data 305 and its rules 310 in multiple, physically separate tables. Considered statically, there is no obvious or easily determined relationship or connection 315 between configuration data 305 and rules 310. At runtime, however, configuration data 305 and rules 310 interrelate 320 because the configuration data 305 and the rules 310 affect each other. For example, some configuration data 305, may affect the execution of rules 310. The physical separation between related data and between data and rules, the lack of static indications of runtime interactions between data and rules, and other factors make the data and processes of a business application difficult to understand, difficult to create, difficult to debug, and difficult to modify without causing unexpected effects.

In view of the foregoing, it is desirable to take business application structures and translate them into user-friendly objects that can be more easily understood, manipulated, debugged, designed, redesigned, analyzed, and modified.

### SUMMARY

Consistent with embodiments of the present inventions, systems, methods and computer readable media are disclosed for modeling of business applications and the use of an OOP model to create, improve, and maintain a business application.

In accordance with one embodiment, a method performed by a computer system is provided for modeling a business application composed in a first programming format by receiving logic entities of the business application; generating, based on the received logic entities, a model representing the business application in a second programming format; and regenerating, based on the processed model, the business application in the first programming format.

In accordance with another embodiment, a method performed by a computer system is provided for translating a business application composed in a first programming format into a model composed in a second programming format by receiving a plurality of table-based data structures of the business application, wherein each table-based data structure includes attributes of the data stored therein; identifying attributes that are common to each of the plurality of table-based data structures; selecting a minimum set of common attributes that allow unique definition of each of the plurality of table-based data structures; using the selected minimum set of common attributes to define one or more translational data structures; and generating the model based on the defined translational data structures.

In accordance with another embodiment, a method performed by a computer system is provided for modeling a business application by identifying a table-based data structure in the business application; defining a transformation rule for converting the table-based data structure into an object-oriented structure, wherein the object-oriented structure reflects a data relationship defined by the table-based data structure; converting the table-based data structure into the object-oriented structure based upon the transformation rule; and expressing the object-oriented structure as an object-oriented programming construct that models the business application.

In accordance with another embodiment, a method performed by a computer system is provided for modeling a business application by identifying a table-based operation structure in the business application; defining a set of rules for converting the table-based operation structure into an object-oriented structure, wherein the object-oriented structure reflects an operation reflected in the table-based operation structure; converting the table-based operation structure into the object-oriented structure based upon the set of rules; and expressing the object-oriented structure as an object-oriented programming construct which models the business application. The business application is a payroll business application in which the table-based operation structure reflects a processing rule of the payroll business application, and the object-oriented structure is a Java class structure.

In accordance with another embodiment, a method performed by a computer system is provided for modeling a business application by identifying, in the business application, a first table-based data structure and a logical connection between the first table-based data structure and a second table-based data structure; defining a transformation rule for converting the logical connection into an object-oriented structure that reflects a logical attribute of the logical connection; converting the logical connection into the object-oriented structure based on the transformation rule; and expressing the object-oriented structure as an object-oriented programming construct. The object-oriented language construct may be an equality operator. The computer system may further flag an unresolved reference made by the object-oriented language construct. It may determine whether to flag using an object-oriented language compiler.

In accordance with another embodiment, a method performed by a computer system is provided for modeling a business application by identifying, in the business application, a first table-based data structure, a second table-based data structure, and a logical connection between the first and second table-based data structures; defining at least one transformation rule for converting the first table-based data structure, the second table-based data structure, and the logical connection into a plurality of object-oriented structures that reflect a logical attribute of the logical connection; converting the first and second table-based data structures and the logical connection into the plurality of object-oriented structures based upon the at least one transformation rule; and expressing the plurality of object-oriented structures as a plurality of interrelated object-oriented programming constructs. The logical connection may be represented in the object-oriented programming constructs by an equality operator.

In accordance with another embodiment, a method performed by a computer system is provided for analyzing a business application by receiving a model representing logic entities of the business application; processing the model using a code compiler to identify a possible exception in the model; and correlating the possible exception in the model to an unused logic entity in the business application. The computer system may display an indicator of the possible exception in the model to depict the unused logic entity in the business application where the logic entities of the business application correspond to a table-based data structure which reflects at least one of configuration data or processing rules of the business application.

In accordance with another embodiment, a method performed by a computer system is provided for redesigning a business application composed in a first programming format by receiving a model representing the business application in a second programming format; processing the model using a code refactoring tool in the second programming format; analyzing a modification to the model made by the code refactoring tool; and applying, in the first programming format, the modification to the business application. Processing the model using the code refactoring tool may include removing redundant code of the model which corresponds to redundant code of the business application, wherein the model is an object-oriented programming construct representing the business application.

In accordance with another embodiment, a method performed by a computer system is provided for analyzing referential integrity of a business application by receiving a model representing the business application; processing the model using a code compiler to identify a compiler exception; correlating the compiler exception in the model to a referential integrity instance in the business application; enabling a correction of the compiler exception in the model; and applying the correction to the business application to correct the correlated referential instance. The computer system may display an indicator of the compiler exception in the model to depict the referential instance in the business application, wherein the model is an object-oriented programming construct representing the business application.

In accordance with another embodiment, a method performed by a computer system is provided for analyzing configuration of a business application by receiving a model representing the business application; displaying the model using a developer interface; receiving a change to the model through the developer interface; and correlating the change to the model to a corresponding configuration change in the business application. The computer system may apply the corresponding configuration change to the business application. It may also model, in the developer interface, how the corresponding configuration change would alter the business application, wherein the model is an object-oriented programming construct representing the business application.

In accordance with another embodiment, a method performed by a computer system is provided for analyzing a business application composed in a first programming format by receiving a model representing the business application in a second programming format; processing the model using a code optimization tool to identify a logic structure error in the model; correcting the identified logic structure error; and applying the corrected logic structure error to the business application. The second programming format is an object-oriented programming format. Processing the model using the code optimization tool may include at least using a code debugger.

In accordance with another embodiment, a method performed by a computer system is provided for analyzing a business application by receiving an object-oriented programming construct representing configuration data and rules defining the business application; processing the object-oriented programming construct using an object-oriented consistency checker tool to identify a logic structure error; flagging the identified logic structure error of the object-oriented programming construct; and correcting the identified logic structure error in the object-oriented programming construct. The computer system may apply the corrected logic structure error to the business application. Applying the correct logic structure error to the business application may further include correcting the configuration data and the rules of the business application.

In accordance with another embodiment, a method performed by a computer system is provided for analyzing a business application composed in a first programming format by receiving a model representing the business application in a second programming format; processing the model to generate a structure of the model; and analyzing the structure of the model to depict a structure of the business application. The depicted structure of the business application includes structure of configuration data and rules of the business application. The second programming format is an object-oriented programming format, and the processing further includes generating a diagram of object classes of the model.

In accordance with another embodiment, a method performed by a computer system is provided for determining a current version of a business application by receiving a first version of an object-oriented programming construct representing the business application, wherein the first version includes a plurality of objects; receiving a second version of the object-oriented programming construct representing the business application, wherein the second version includes a plurality of objects; receiving a third version of the object-oriented programming construct representing the business application, wherein the third version includes a plurality of objects; comparing the objects of the first version, the second version, and the third version of the object-oriented programming construct; identifying differences between the first version, the second version, and the third version of the object-oriented programming construct; determining, for each identified difference, which version of the object-oriented programming construct is to be associated with the first version of the object-oriented model; and assigning the first version of the object-oriented programming construct as a current version of the object-oriented programming construct.

In accordance with another embodiment, a method performed by a computer system is provided for modeling a business application composed in a first programming format by processing a model representing the business application, wherein the model is composed in a second programming format; determining, based on the processed model, a potential problem in the business application; and identifying the determined potential problem by displaying a marker in the model of the business application. Identifying the determined potential problem further includes displaying the marker in the model at a location where the potential problem occurs. The computer system may associate the displayed marker with information describing the determined potential problem.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIGS. 1 to 3 illustrate exemplary business structures of a business application;

FIG. 4A illustrates a flowchart illustrating an overview of an exemplary process 400 for creating an off-line model of a business application, consistent with the present invention;

FIG. 4B is an exemplary illustration 440 of the various processing tools consistent with the invention;

FIGS. 5 to 8 illustrate exemplary processes consistent with the present invention;

FIGS. 9 to 15 illustrate exemplary processing tool operations consistent with the present invention;

FIG. 16 illustrates an exemplary process consistent with the invention; and

FIGS. 17 to 60 illustrate exemplary user interface displays consistent with the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

SAP applications, built around their latest R/3 system, provide the capability to manage financial, asset, and cost accounting, production operations and materials, personnel, plants, and archived documents. The R/3 system runs on a number of platforms including Windows 2000 and uses the client/server model.

R/3 is a comprehensive set of integrated business applications. R/3 provides the ability to store, retrieve, analyze, and process in many ways corporate data for financial analysis, production operation, human resource management, and most other business processes.

At one level, an R/3 system (or other legacy business application system) may be thought of as a collection of legacy business structures or business objects held primarily in databases (as tables) that are manipulated by business processes or workflows.

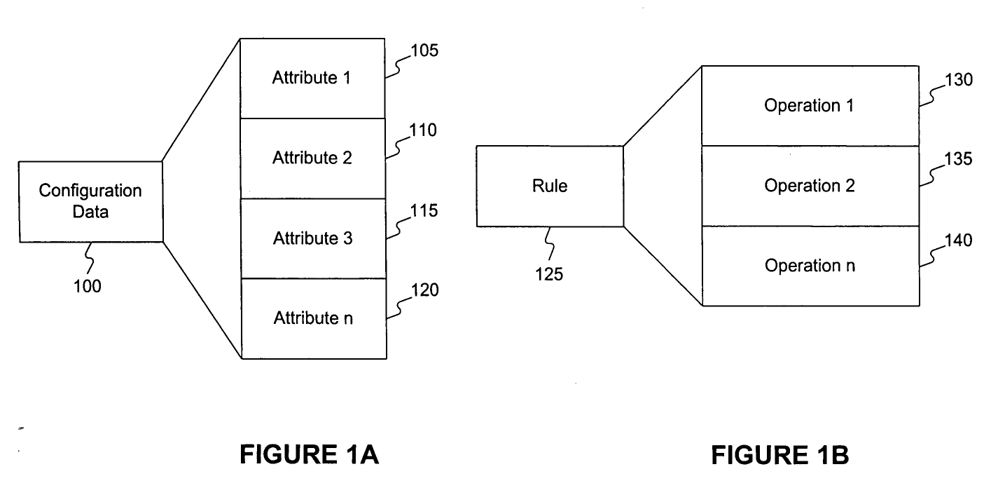

For example, as shown in FIG. 1A, an exemplary business structure includes configuration data 100, which is one or more business data objects containing data used by a business process. Configuration data 100 includes several data fields called attributes, such as “attribute 1” 105 through “attribute n” 120. Configuration data 100 may include, for example, data such as an employee's name, an hourly wage rate, and indicators for directing processing of data for the employee. Exemplary business structures also include business rules, such as rule 125, which are typically made up of multiple operations, such as “operation 1” 130 through “operation n” 140. Rule 125 may be, for example, a series of operations that when executed will cease deducting social security payments after an employee's cumulative salary reaches a specified amount.

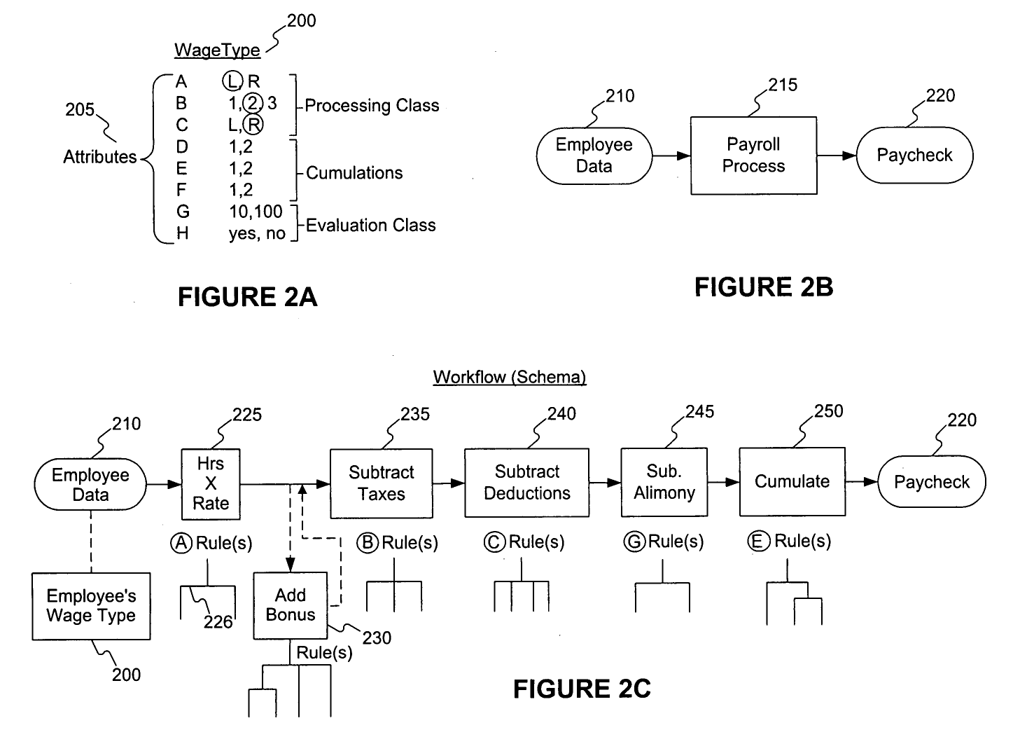

In systems such as R/3, configuration data and rules control business applications. As shown in FIG. 2A, in an exemplary payroll processing business application, the business structures may include a wagetype 200, which may be a business data object containing configuration data used to configure portions of a paycheck. For payroll processing purposes, each employee may have associated with him or her one or more wagetype structures containing data about the employee that is used to perform the payroll functions. For example, an employee may have a wagetype for hourly rate, a wagetype for union fees, a wagetype for deductions, etc. Each wagetype may include one or more attributes 205 that act as configuration elements, shown as attributes A-H. The attributes themselves may be of different types. For example, as shown, attributes A-C may be processing class attributes, which control the processing path used by the business application when performing processing (rules) for the employee. Attributes D-F may be cumulation attributes, which identify wage types that relate to one another and are processed together in some instances. Attributes G and H may be evaluation class attributes, which control processing paths like processing class attributes, but for different rules. A wage type 200 may include other types of attributes 205, as well.

As shown in FIG. 2B, as one of its functions, an exemplary payroll processing application 215 takes employee data 210 as input and produces a paycheck 220 as output. At runtime, each employee record is processed based on the employee's data 210 to produce the employee's paycheck 220.

FIG. 2C illustrates this exemplary process in greater detail. As shown in this example, employee data 210 is contained in the employee's wagetype(s) 200 or similar organized data structure stored in one or more databases. These data structures contain the data used by, and to control, process 215 that calculates and produces a paycheck 220.

More specifically, employee data 210 from the employee wage type 200 may be used by a workflow or schema that implements payroll process 215. In the example shown, the first function in the workflow, the “HRS x RATE” function 225, multiplies the employee's hours worked by the employee's hourly wage rate. The data specifying the hours and hourly rate may be derived from the employee's wage type 200. As shown in this example, information regarding how to perform the “HRS x RATE” function 225 is specified by a rule(s) 226 associated with the function. The functioning of the rule(s) 226, and thus the functioning of the “HRS x RATE” function 225 may be affected by attributes 205 contained in the employee's wage type 200. For example, as shown in FIG. 2A, a processing class attribute 205, such as attribute A, may have “L” selected for this employee and “R” unselected. Selecting “L” may cause rule(s) 226 associated with the “HRS x RATE” function 225 to calculate the product in a different manner than if “R” were selected for attribute A. For example, “L” may cause the hourly rate to increase by 1.5 for hours greater than 40, such that the employee gets paid time and a half for overtime beyond 40 hours, while “R” would not use an hourly rate increase, for an employee who is not eligible for increased overtime pay.

As shown in FIG. 2C, the next function to be performed in the workflow may be either the “ADD BONUS” function 230 or the “SUBTRACT TAXES” function 235. Typically, data from the employee's wage type 200 will indicate whether the employee is to receive a bonus and control the workflow to determine which of the two functions is performed next. As explained with respect to the “HRS x RATE” function 225, the rules associated with the “ADD BONUS” function 230 or the “SUBTRACT TAXES” function 235 determine how those functions are performed, and attributes 205 from the employee's wage type 200 may affect the functioning of the rules.

Similarly, the “SUBTRACT DEDUCTIONS” function 240, “SUBTRACT ALIMONY” function 245, and “CUMULATE” function 250 are performed as the illustrated workflow progresses, and the rules associated with each function may be similarly affected by the corresponding attributes 205 in the employee's wage type 200.

After all the workflow functions are completed, the payroll process shown produces a paycheck 220 for the employee reflecting the results of the operations carried out by the functions.

Other business applications, such as financial applications, asset accounting applications, cost accounting applications, production operations applications, etc., use business structures and workflows comparable to the payroll processing application represented in FIGS. 2A-2C.

Systems and methods consistent with the invention analyze a business application's data, operations, and relationships and create a corresponding object oriented programming (OOP) object, model, comprising OOP objects, functions, and operators corresponding to the business application entities. In one embodiment the OOP model is realized in the Java programming language. Each OOP model entity accurately represents the data, relationships, and rules associated with the corresponding business entity. Once converted to an OOP model, standard OOP tools may be used to understand, manipulate, design, redesign, analyze, and modify the business application. This can be done independently of the native business application system, as the OOP objects are separate and independent from the business application entities. Modified OOP objects may be converted into business application entities and installed in the native system.

### I. Detaching Application into Offline Mode

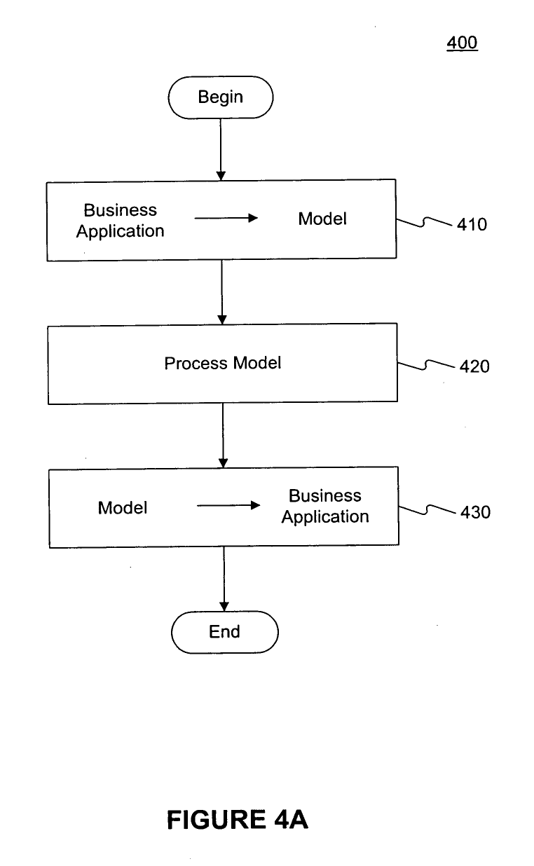

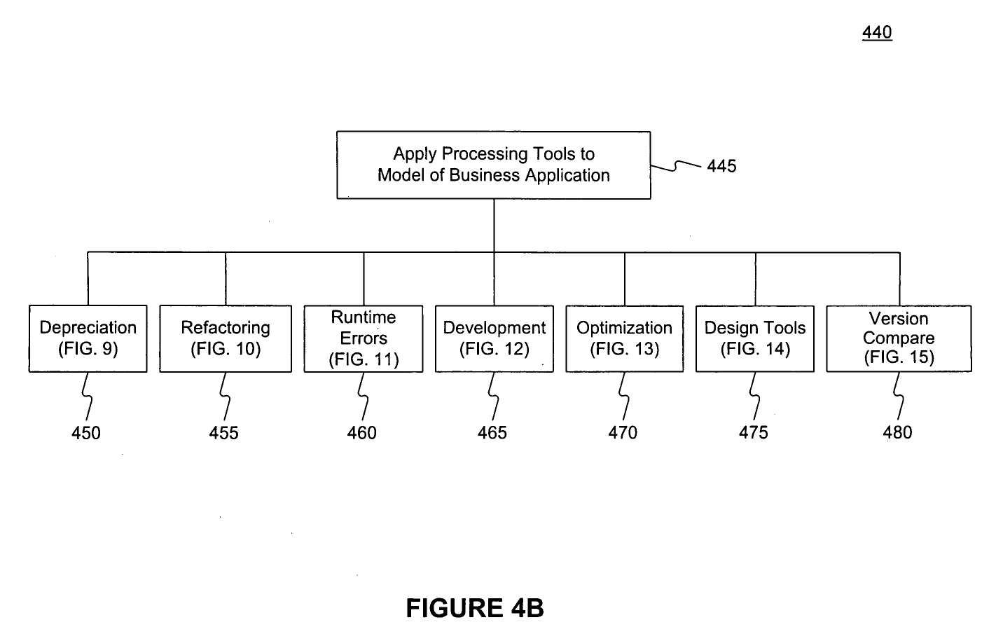

FIG. 4A illustrates a flowchart illustrating an overview of an exemplary process 400 for creating an off-line model of a business application, consistent with the present invention. The exemplary process is applied to a business application composed in a first programming format. The programming format for such business applications, as described above, are often specialized programming formats unique to each particular business application, and typically have limited flexibility in how a programmer may conduct efficient programming or debugging tasks.

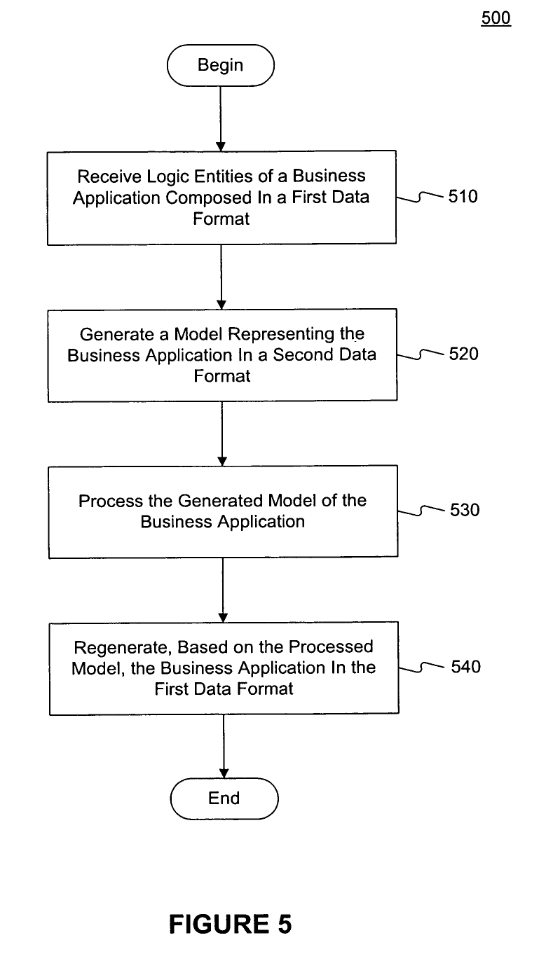

As shown, in FIG. 4A, systems consistent with the invention may translate the business application into a model representing the business application (stage 410). More particularly, the model reflects a representation of the business application in a second programming format different than the original or first programming format of the business application. In preferred embodiments of the invention, the second programming format may be an object-oriented programming (OOP) language, such as Java or C++. The process for translating the business application into a model is described in greater detail below with respect to FIGS. 5 to 8.

Once the system has generated the model of the business application, the system may then enable a user to process the model in a processing environment or platform corresponding to the second programming format (stage 420). For example, as described above, the second programming format may be an OOP language, such as Java. Systems consistent with the invention may thus enable a user to program, debug, or analyze the programming code of the model by using an OOP editor or other type of OOP processing environment or platform. Because the user may process the model, as opposed to the actual business application, the user may do so while business application is still running. Thus, systems consistent with the invention allow a user to process a business application without interfering with normal business activities.

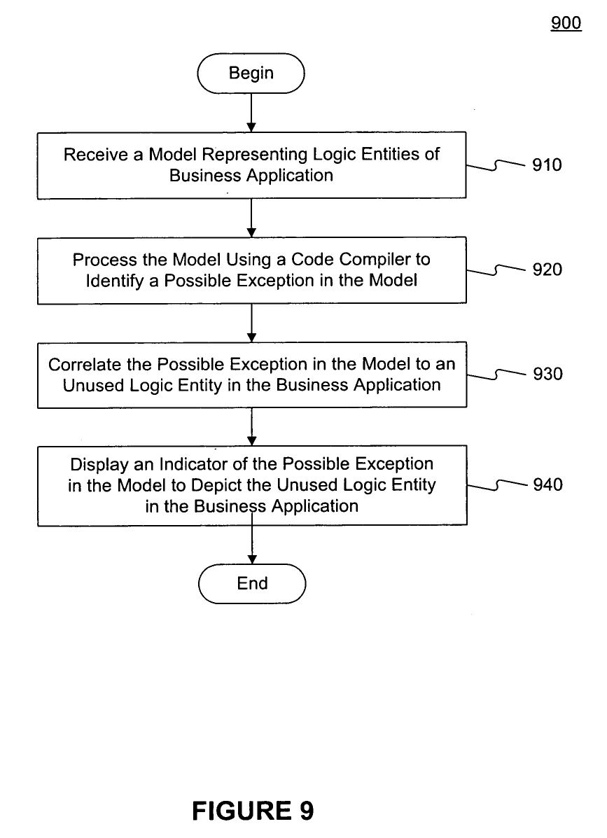

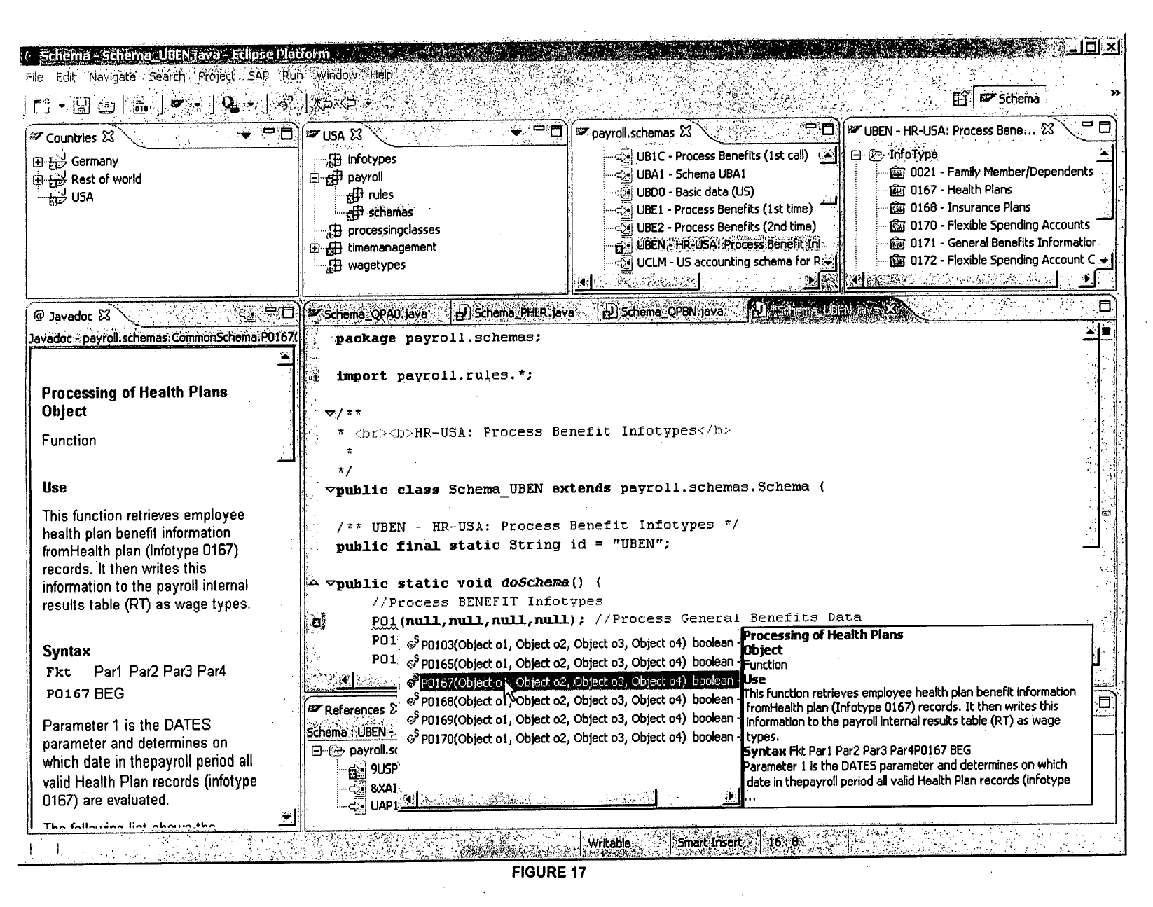

Further, by taking advantage of processing tools available with such OOP processing environments, the system may enable a user to use one or more tools to process the model. FIG. 4B is an exemplary illustration 440 of the various processing tools consistent with the invention. As shown in FIG. 4B, the system may enable a user to apply the processing tools to the model of the business application (stage 445). These processing tools may include a deprecation process (stage 450), a refactoring process (stage 455), a runtime error process (stage 460), a development process (stage 465), an optimization process (stage 470), a design tools process (stage 475), and a version compare process (stage 480). These and other processing tools consistent with the invention are described in greater detail below with respect to FIGS. 9 to 15. Further, FIGS. 17 to 22 illustrate exemplary user interface screens enabling a user to process the model representing the business application.

The system may then re-translate the model representing the business application in the second programming format back to the first programming format (stage 430). As described below, systems consistent with the invention may translate the model in such a way that any modifications made to the model in the second programming format are automatically reflected in the re-translated business application composed in the first programming format. The process for re-translating the model back to the first programming format is essentially the reverse of the forward translation process described above with respect to stage 410, and as illustrated below with respect to FIGS. 5 to 8.

FIG. 5 illustrates the exemplary modeling process 500 of FIG. 4 in greater detail. As shown in FIG. 5, to translate the business application into the second programming format, the system receives the logic entities of the business application composed in the first programming format (stage 510). As described above with respect to FIG. 1, these logic entities may be the business structures (e.g., configuration data 100 and business rules 125) of the business application. Based on the received logic entities of the business application, the system may then generate a model representing the business application in the second programming format (stage 520). As also describe above, the second programming format may be, for example, an OOP language such as C++ or Java. The system may then, as described above with respect to FIG. 4, process the generated model of the business application (stage 530). The system may then re-translate the processed model to regenerate the business application in the first programming format (stage 540).

### II. Transforming Application by Identifying “Least Common Denominator”

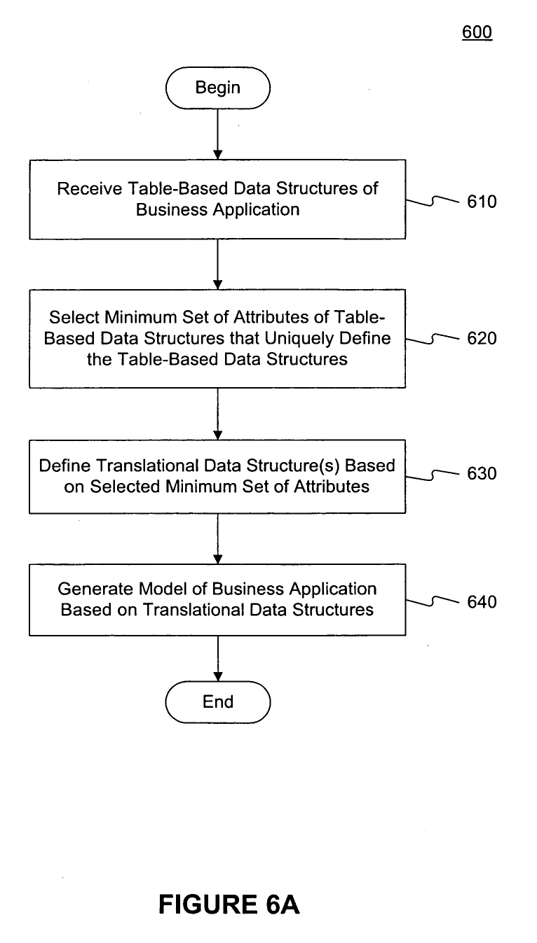

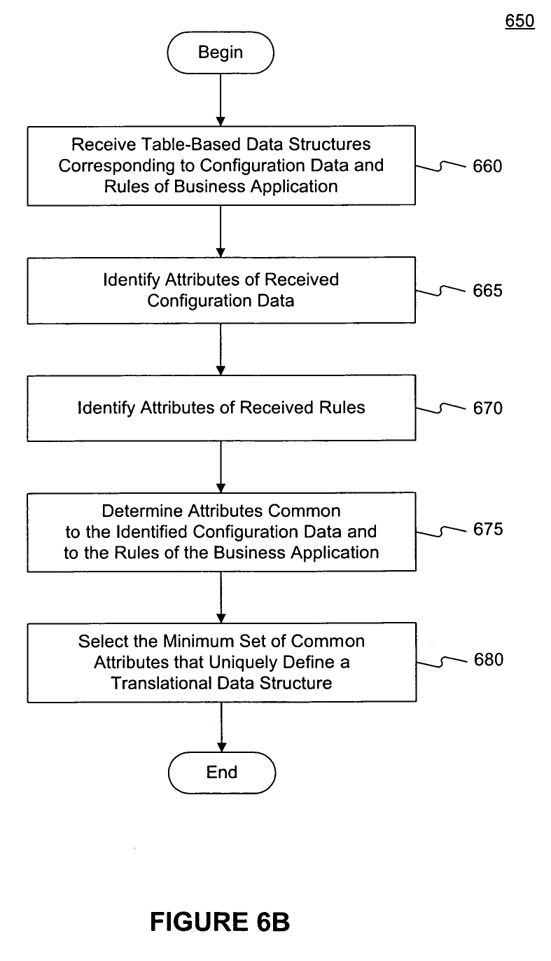

FIG. 6A illustrates an exemplary process 600, consistent with the invention, for translating the business application into a model composed in the second programming format. As shown in FIG. 6A, the system may receive the table-based data structures of the business application (stage 610). In this regard, the system may scan the business application to identify the table-based data structures, which may be any group or segment of data reflecting data stored in a table-based format of the business application. The table-based data structures may, for example, correspond to configuration data and rules of the business application. Further, each table-based data structure may include attributes of the data stored in the respective table-based data structure. For instance, as explained above with respect to FIG. 1, the table-based data structures may include configuration data 100 having attributes 105 to 120 and rule 125 having operation attributes 130 to 140.

The system may then select the minimum set of attributes of table-based data structures that uniquely define the table-based data structures (stage 620). To this end, the system may first identify those attributes of, for example, the configuration data (e.g., attributes 105 to 120) and any rules (e.g., operation attributes 130 to 140). The system may then identify those attributes that are common to each table-based data structure. From the identified common attributes, the system may then select the least number of these common attributes that uniquely defines each translational data structure.

Based on the selected minimum set of attributes, the system may then define one or more translational data structure(s) (stage 630). In systems consistent with the invention, a translational data structure may be an identified data or business structure of the business application that is converted into an object-oriented structure. For example, in an R/3 payroll application, the minimum set of attributes may include a geographic attribute (e.g., “New Zealand”), a version reference attribute (e.g., “rna”), and a client reference attribute (e.g., “800”). The corresponding translational data structure may thus be defined as NewZealand.ma.800. In OOP terms, the defined translational data structures may include at least one translational data structure that respectively corresponds to a project, an object, and an object instance. The system may then generate the model of the business application based on the defined translational data structures (stage 640).

FIG. 6B illustrates an exemplary process 650 further describing the processing stages of FIG. 6A. As shown in FIG. 6B, the system may receive table-based data structures corresponding to configuration data and rules of business application (stage 660). The system may then identify the attributes of received configuration data (stage 665) and identify the attributes of received rules (stage 670). The system may then determine those attributes common to the identified configuration data and to the rules of the business application (stage 675). From these common attributes, the system may then select the minimum set of common attributes that uniquely define a translational data structure (stage 680).

### III. Transforming Application Layer Structure into OOP Objects

Business applications often involve large, complex, table-driven legacy systems. The business objects or business structures that hold the data in such systems may be contained in 10 or more different database tables, and similarly, the rules that drive such systems may be contained in multiple tables, separate from the data tables. These table-centric structures are difficult for users and administrators to comprehend, manage, create, revise, and debug.

Methods and systems consistent with the invention transform business application structures into OOP objects that represent the data, relationships, and operations of the business application structures. The business application structures are transformed at the application level, including consideration of application logic, as opposed to the database table level. Thus, a complex business structure comprising ten or more related database tables, such as a wagetype in an SAP R/3 payroll processing application, may be transformed into a single OOP object, such as a Java class, that encompasses all the information in the ten or more related database tables.

In some embodiments consistent with the invention, business structures are transformed into a hierarchical object-oriented class structure. For example, all the business structures in an application are analyzed to identify common elements or attributes, and transformation involves defining an OOP superclass that represents the common elements. Then, specific business structures are analyzed to identify their unique elements, and each specific business structure is transformed into an OOP object by defining subclass instances of the superclass, which add representations of the unique elements of the business structure to the superclass. This exposes the hierarchy of the business structures to a user or administer viewing the OOP objects. Included in the transformation to subclasses is extraction of the data from the business structure for inclusion in the subclass. Thus, the values of various fields are also exposed to users. For example, OOP object “WageType_s123” is a subclass that extends the “WageType” superclass and corresponds to the S123 business structure in an R/3 payroll application.

In some embodiments, transformation is based on a set of rules defining what OOP object to create or define for each business structure that is encountered in the business application. In one embodiment, the set of transformation rules may be defined manually. The rules for translating a business application structure into an OOP object should create syntactically correct OOP objects that are useful for processing at the business application level. For example, one transformation rule for grouping various business structures may be to bundle them according to whether they share operations that can be performed on them. Another rule may be to create a subclass for each different time period attribute of a business structure based on start date and end date value of the time period attribute. Another rule may be to, within a subclass, define each business structure configuration element, such as processing class attribute, as an OOP operation in that class. Yet other rules may define when to use a public, private, or shared OOP class to determine what will be visible to user. Yet another rule may be to take each business object as defined by the business application and create a corresponding OOP object, effecting a one-to-one mapping.

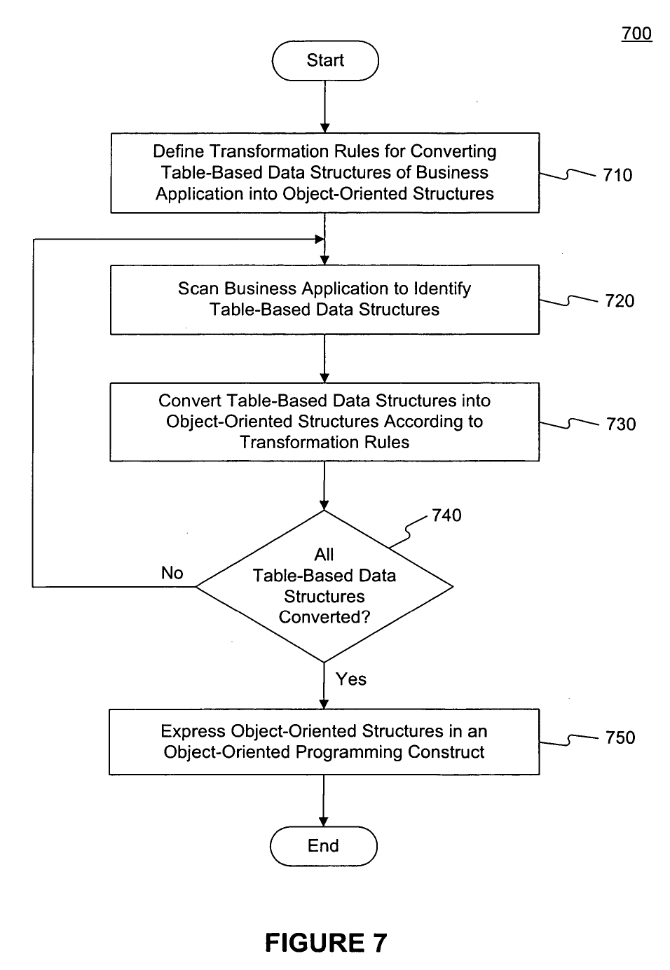

FIG. 7 illustrates an exemplary process consistent with the invention. As shown, the process begins by defining transformation rules for converting table-based data structures of a business application into object-oriented structures. Next, the process scans the business application to identify a table-based data structure. Next, the process converts the identified table-based data structure into an object-oriented structure, according to the transformation rules.

The process then determines whether all the table-based data structures in the business application have been converted into object-oriented structures. If not, the process loops up and continues to identify and convert. If so, then the process expresses the object-oriented structures in an object-oriented programming construct, such as an OOP class that represents the table-based data structure.

### IV. Exposing a Sequence of Application Operations by Emulation in an Object-Oriented Language

As with data structures in legacy business applications, the operations, instructions, or business rules that implement the application are typically table-based. Similar to business data structures, business rules or operations may be contained in many different database tables. Perhaps worse, there may be no physical connection between the rules tables and the data tables they operate on and vice-versa. These table-centric rules are difficult for users and administrators to comprehend, manage, create, revise, and debug.

Methods and systems consistent with the invention transform business application operations or rules into OOP constructs that represent the operation or rule, emulate its operation in sequence with other operations, and represent its relationship(s) to the data it operates with and upon. In one embodiment, an automated system determines each operation that makes up a schema or rule in the business application by analyzing the database table(s) that hold the schema or rule. A schema may be thought of as a business process or workflow that connects rules and data structures. For each business operation found, the system declares or creates an empty OOP language function of the same name, such as a Java function. The system may insert a standard number of parameters to make syntax of the newly declared OOP function valid. The system then puts the OOP functions in the same sequence as the business application operations. In one embodiment, the OOP language code representing the business operations contains function calls only; the body of the functions are empty. OOP languages such as Java allow a null function body and can compile the function call even without the function body. For example, for the business application operation “NUM=,” the system may create a null Java function named “NUM=.” Since the OOP language syntax is correct, OOP language tools, such as compilers, analyzers, optimizers, etc. can be used to find errors or problems in the relationships, calls, interactions, design, etc. associated with the null functions and therefore the business rules and operations they represent. For example, if a call is made to a OOP function that does exist (because there is no corresponding business application operation that caused it to be created), this error will be exposed by the OOP language tools, such as a compiler or linker.

In some embodiments consistent with the invention, the null OOP functions include documentation pulled from the business application to help users understand the function.

In some embodiments consistent with the invention, the process that transforms business application operations or rules into OOP constructs that represent the operation or rule is controlled by a set of transformation rules. These transformation rules may be generated manually. The transformation rules should be designed such that the resulting OOP language function enforces the scope and other characteristics of the business application operation through OOP language techniques. For example, a business application rule (and therefore the operations that comprise it) may be valid for only one country, or in a few countries, or in all countries. To enforce this scope, the transformation rules may produce functions of appropriate scope, such as global, shared, or local. In some embodiments, an OOP project model may also be used to enforce the scope of OOP objects and functions.

### V. Exposing Application Layer Integrity Using OOP Language Elements

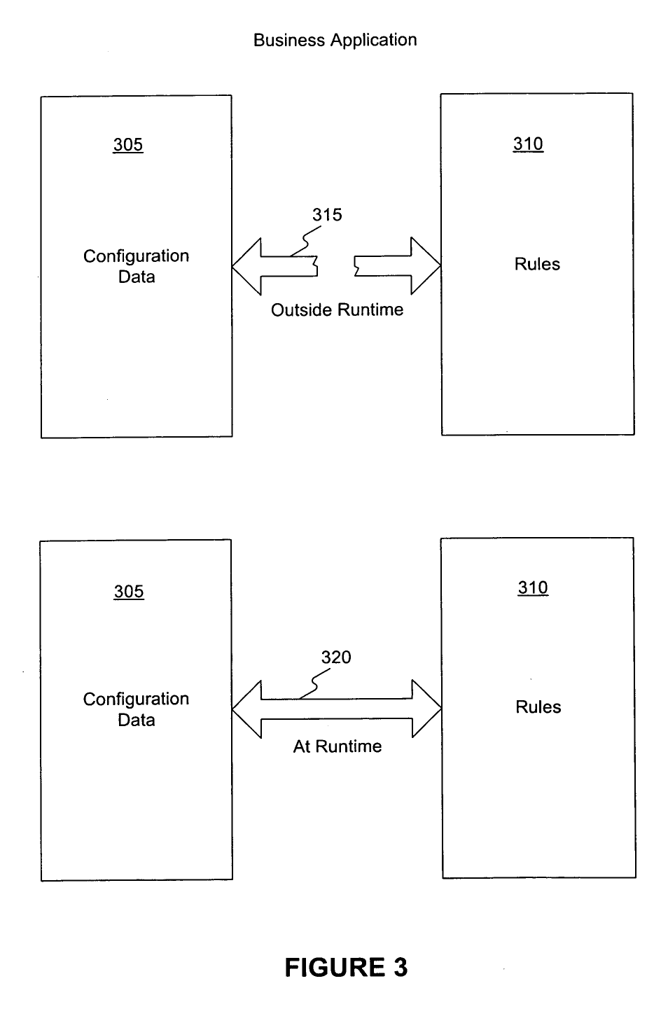

As with data structures and operations in business applications, the relationships or links between the business data and business operations are typically table-based, making the relationships difficult, at best, to discern. For example, as illustrated in FIG. 3, the relationships between configuration data 305 and business rules 310 may not be realized until runtime. This makes it difficult for users and administrators to detect errors in the relationships, such as missing business data that is referred to by other data or a business rule, especially when working with the static tables at a time other than run time.

Methods and systems consistent with the invention transform business application relationships or links into OOP constructs that represent the relationship, tying together related data and operations in an easily comprehensible and manageable manner, and in a manner that allows automated OOP tools to check the integrity of the relationships. In one embodiment, an automated system uses an object-oriented language construct, such as an equality operator (e.g., “=” in Java), to link together OOP objects representing business data and business operations. The object-oriented language construct binds different objects representing business entities and shows and enforces a relationship between them. For example, a business rule that is affected by a processing class attribute in a wagetype may have that link represented by an equal sign, perhaps in an “if” function.

Representing the business object relationships as OOP language constructs such as “=,” allows the use of a OOP language debugger, such as a Java debugger, to walk through referential relationships and discover referential problems in the integrity of the business application layer. For example, the value of a processing class attribute may be directly expressed in the definition of wagetype. In one embodiment, an equal sign representing the relationship between the value and processing class may be generated when the Java code is created. Thus, when trying to resolve the equal sign relationship, a Java compiler will be able to identify broken links, which represent empty links in the business application. Consequently, for an instance of wagetype, for example, a user can see from the Java code model what processing classes are not defined (and so not allowed), and can see what values are acceptable for each processing class. These are examples of integrity checks for the business application.

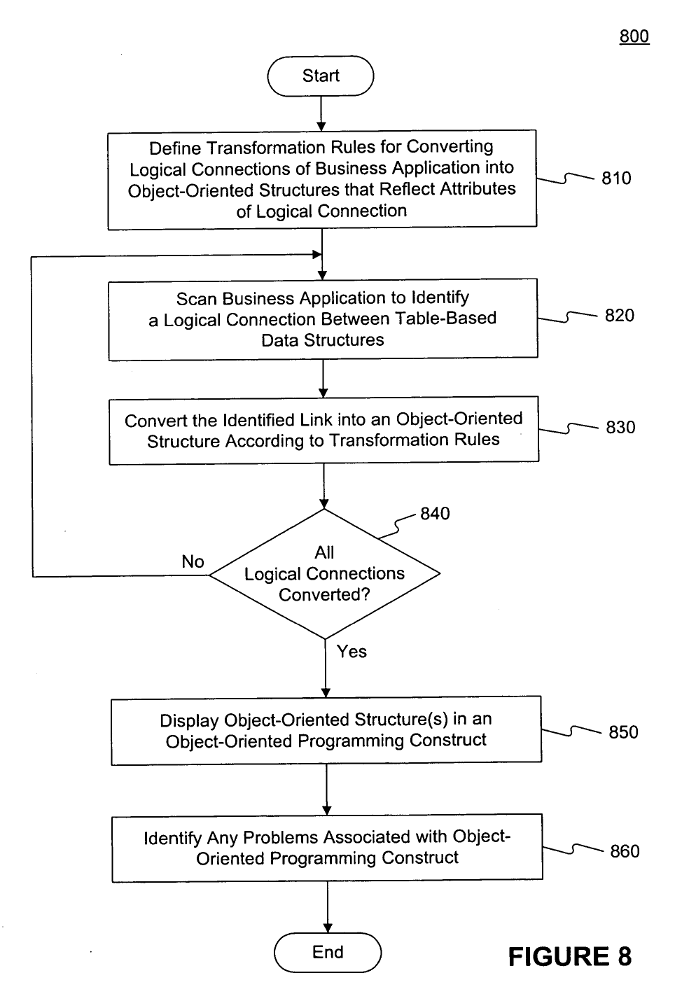

FIG. 8 illustrates an exemplary process consistent with the invention. As shown, the process begins by defining transformation rules for converting logical connections from a business application into object-oriented structures that represent the logical connections. Next, the process scans a business application to identify a logical connection or link between table-based data structures or between table-based data structures and rules. Next, the process converts the identified logical connection or link into an object-oriented structure, according to the transformation rules. In one embodiment, the transformation rules include using the equality operator of an OOP language as the object-oriented structure. In some embodiments, the transformation rules are defined manually according to criteria similar to that described for transforming business structures and business rules.

The process then determines whether all the logical connections or links in the business application have been converted into object-oriented structures. If not, the process loops up and continues to identify and convert logical connections. If so, then the process displays the object-oriented structures as an object-oriented programming construct, such as an equal sign between related business data and/or business operation representations.

In the embodiment shown, the process then identifies any problems associated with the object-oriented structure, such as an unresolved reference or other integrity problem. Such problems may be identified by convention OOP language tools, such as compilers and linkers. Any such problem represents a problem in the corresponding business application structures and relationships, and the OOP language constructs model the relationships and behaviors of the business application from which they are derived.

### VI. Exposing Business Configuration Dependencies

As with data structures and operations in business applications, the relationships or links between the business data and business operations are typically table-based, making the relationships difficult, at best, to discern with the table-centric views and tools provided by a typical business application system. For example, as illustrated in FIG. 3, the relationships between configuration data 305 and business rules 310 may not be realized until runtime, making it difficult for users and administrators to comprehend, manage, create, revise, and debug such relationships, especially by working with the static tables before runtime.

Methods and systems consistent with the invention transform business application relationships or links into OOP constructs that represent the relationship, and display the relationship and the related business objects in an easily comprehensible and manageable manner.

In one embodiment consistent with the invention, the system takes Java code, the data in tables, and the data structure of tables and generates an outline to expose the structure of business objects. In the outline, related business objects are displayed side by side. For example, an R/3 data structure may be displayed in a tree form in one window next to a display of the Java code representing the data structure in another window, showing the dependencies between objects in the business application configuration.

### VII. Exposing Missing Logic Entities of a Business Application as Deprecated

Business applications often involve large, complex legacy systems. Over time, these systems evolve to accommodate changing business rules, user needs, etc. Each change to a business application may affect many logic entities within the business application. For example, changing a processing rule may result in another logic entity, such as configuration data, that is no longer used by the business application. However, because the business application is large and complex, the user making the change may be unaware that the logic entity is now unused and could be deleted. Instead, the unused logic entity remains in the business application even though it is never again used.

As time passes, a business application may develop a great deal of unused, or “deprecated” logic entities, including configuration data and processing rules. Traditional table-based business applications do not have a mechanism for identifying or removing deprecated logic entities. This results in wasted storage space and unnecessary programming complexity associated with conventional business applications.

Using methods and systems consistent with the present invention, deprecated logic entities of a business application may be identified using an object-oriented model of the business application. By transforming business application structures into object-oriented structures, deprecated logic entities in the business application may be exposed using object-oriented referential integrity checking.

Each logic entity in a business application may be transformed into a corresponding object-oriented structure. An object-oriented compiler may then be used to check the referential integrity of the object-oriented structures. Although the object-oriented compiler thinks it is finding problems, such as broken references, in object-oriented code, it is actually identifying problems in the underlying business application. For example, the object-oriented compiler may identify a reference to a branch of code that will never be executed. By correlating the identified branch of code with its corresponding logic entity in the business application, a deprecated logic entity is identified. In one embodiment, deprecated logic entities may be removed from the business application after they have been identified using the object-oriented model.

In one example, a business application logic entity, such as “wagetype,” may not be defined in the business application for a certain country such as New Zealand. However, “wagetype” cannot be deleted from the business application altogether because it is defined for other countries. During transformation, the object-oriented structure corresponding to wagetype in New Zealand may be created but marked as deprecated to indicate that it is unused in the underlying business application. Deprecated structures may be marked, for example, using yellow underline in displayed object-oriented programming language. Yellow might be used because the deprecated structure is not an error that needs to be fixed (which might be shown in red). In this way, a user viewing the object-oriented structure is alerted to deprecated structures in the business application and can more readily see the effects of changes.

In an embodiment of the present invention shown in FIG. 9, a model representing logic entities of the business application is received. The model is processed using a code compiler to identify a possible exception in the model, and the possible exception in the model is correlated to an unused logic entity in the business application. An indicator of the possible exception may be displayed in the model to depict the unused logic entity in the business application.

### VIII. Optimizing Application Layer Structures by Refactoring

Business applications often involve large, complex legacy systems. Over time, these systems evolve to accommodate changing business rules, user needs, etc. Each change to a business application may affect many logic entities within the business application. For example, changing a processing rule may result in another logic entity, such as configuration data, that is no longer used by the business application. Furthermore, changes to the business application can make an already complex system even more unwieldy to understand and maintain. These difficulties are compounded by the fact that table-based business applications do not allow the use of design techniques available in other types of systems.

Refactoring is a well-known programming technique for improving the design of existing software code without altering the code's behavior. Refactoring may improve code by, for example, consolidating many statements into one, decomposing long methods into shorter ones, eliminating redundancies, etc. Refactored code may be easier to read and understand, simpler to debug, and more efficient to maintain.

Systems and methods consistent with the present invention enable the use of refactoring to reorganize the configuration of a business application. By transforming business application structures into object-oriented structures, object-oriented refactoring tools may be used to retool the underlying business application.

Each logic entity in a business application may be transformed into a corresponding object-oriented structure. An object-oriented refactoring tool may then be used to refactor the resulting object-oriented structures. The refactoring tool will improve the object-oriented structures by, for example, consolidating many statements into one, decomposing long methods into shorter ones, eliminating redundancies, etc. However, the operation of the code will not be affected. Once refactoring of the object-oriented code is completed, the object-oriented code may be translated back into its corresponding business application logic structures. In this way, the business application will reflect the improvements made by refactoring the object-oriented code.

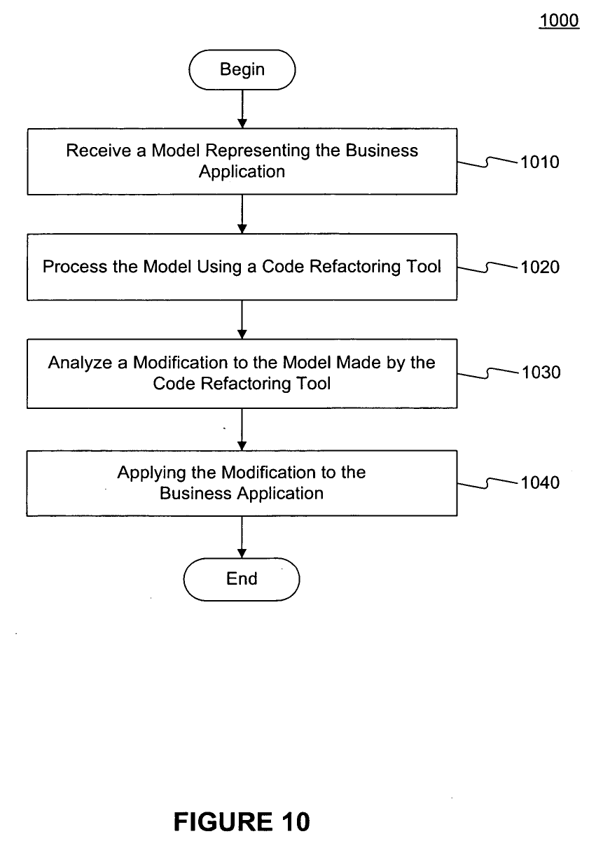

In one method consistent with the present invention shown in FIG. 10, a business application composed in a first programming format is redesigned by receiving a model representing the business application in a second programming format and processing the model using a code refactoring tool in the second programming format. Modifications to the model made by the code refactoring tool are analyzed and applied, in the first programming format, to the business application. In one example, the code refactoring tool includes removing redundant code of the model which corresponds to redundant code of the business application.

### IX. Identifying Runtime Errors of a Business Application

Business applications often involve large, complex legacy systems. Over time, these systems evolve to accommodate changing business rules, user needs, etc. Each change to a business application may affect many logic entities within the business application, resulting in errors that may not be apparent until runtime. For example, changing configuration data related to a project may result in a call to a processing rule that does not exist for that project. However, because the business application is large and complex, the user making the change may be unaware that the call will result in an error during configuration. Instead, the user may not realize the error until runtime, when it is costly and time-consuming to correct. Traditional table-based business applications do not have any simple mechanism for identifying or removing runtime errors at design time.

Using methods and systems consistent with the present invention, runtime errors in a business application may be identified prior to runtime using an object-oriented model of the business application. By transforming business application structures into object-oriented structures, runtime errors (such as unresolved references) in the business application may be exposed using object-oriented referential integrity checking.

Each logic entity in a business application may be transformed into a corresponding object-oriented structure. An object-oriented debugger may then be used to identify errors, such as syntax errors, in the object-oriented structures. Although the object-oriented compiler thinks it is finding problems in object-oriented code, it is actually identifying problems in the underlying business application. For example, the object-oriented debugger may identify a reference to a branch of code that does not exist. By correlating the identified branch of code with its corresponding logic entity in the business application, a problem with dependencies in between business application structures may be identified. In one embodiment, a user may correct the problems in the object-oriented code and translate the corrections back to the business application before running the business application.

A runtime error in the business application may be, for example, calling a rule that does not exist for a project, such as a country, or attempting to create a wagetype that does not exist for a project, such as a country. In one embodiment, when business application structures are transformed into object-oriented structures, a referential error might be revealed by a class that is declared but empty. These errors, once identified using the object-oriented model, may be displayed using, for example, red underline to show that runtime errors will occur in the business application. The identifier may be propagated up through a number of user interfaces to show potential problems at any level of the system.

In traditional table-based business applications, a log file may be created to trace the path of processing during a sample run (e.g., a payroll run) of the business application. The log file may note errors present in the business application. However, the log file is typically long and difficult to debug. By using object-oriented programming constructs, debugging is greatly simplified. The sequential view of a log file is replaced by an object-oriented data representation view that is familiar to developers today. In this way, the same data used for debugging may be presented in a much more user-friendly fashion. In one embodiment, the debugging may be performed offline, increasing efficiency and flexibility of maintaining the business application.

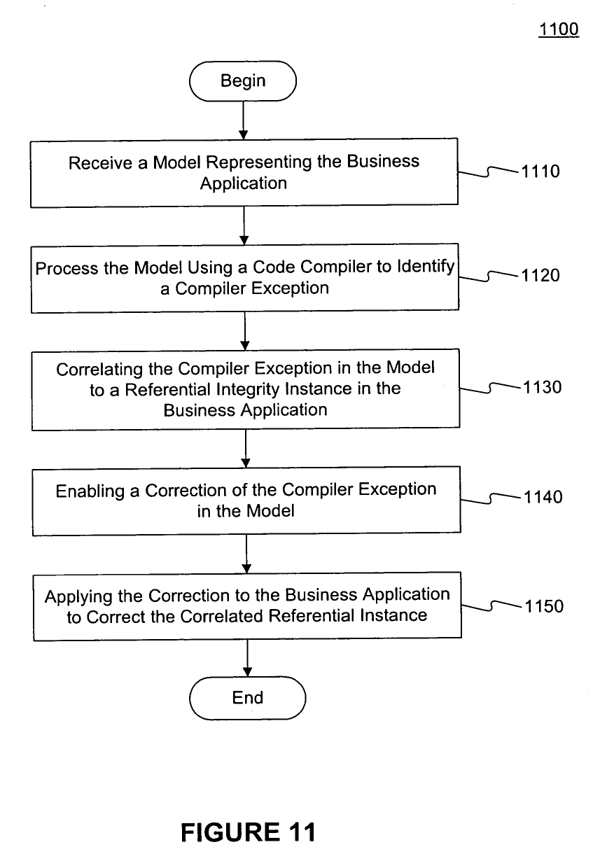

In a method consistent with the present invention shown in FIG. 11, referential integrity of a business application is analyzed by receiving a model representing the business application and processing the model using a code compiler to identify a compiler exception. The compiler exception in the model is correlated to a referential integrity instance in the business application, and correction of the compiler exception in the model is enabled. Finally, the correction to the business application is applied to correct the correlated referential instance. An indicator of the compiler exception in the model may be displayed to depict the referential instance in the business application.

### X. Using an IDE as Configuration Tool

Business applications often involve large, table-based systems. Highly trained consultants may be employed to implement and configure a business application for a company. Due to the complexity of traditional business applications, it may take years to configure an application for a single company. Business applications typically have limited development tools to assist in the configuration and maintenance of the applications.

An interactive development environment (IDE) is a set of tools available to assist a software developer in writing and maintaining software code. IDEs enable users to design and manipulate code, such as object-oriented code, in an easy-to-understand manner.

Systems and methods consistent with the present invention enable business application consultants to configure and maintain business applications using an interactive configuration environment that offers the simplicity and usability of an IDE.

By transforming business application structures into object-oriented structures, object-oriented IDE tools may be applied to configure the corresponding business application. For example, users can write a new rule using familiar object-oriented code, and that code may be converted into logic entities to apply the new rule in the business application. In another example, users may view existing business applications using an IDE interface. In this way, users may not need to worry about the format or structure of the business application but may still be able to configure it.

When business application structures are displayed using object-oriented code structures, the business meaning of the object-oriented code structures may also be displayed. For example, when a user rolls a mouse over an item in the object-oriented code, documentation of the underlying business meaning may be displayed in a pop-up box. This aids the user in understanding a complex business application using familiar, easy-to-understand object-oriented programming constructs.

Using an object-oriented user interface, the user may browse business application logic entities and related objects using a common object-oriented display. Object-oriented code assists and templates may be available to assist users in writing new object-oriented code in order to add new logic entities to the business application. A template may consult a translation key to determine syntax, parameters, etc. and display these options in a drop-down list in the object-oriented code display. Using IDE tools, a state of the business application may be compared with a changed state of the business application, for example, by using a side-by-side display.

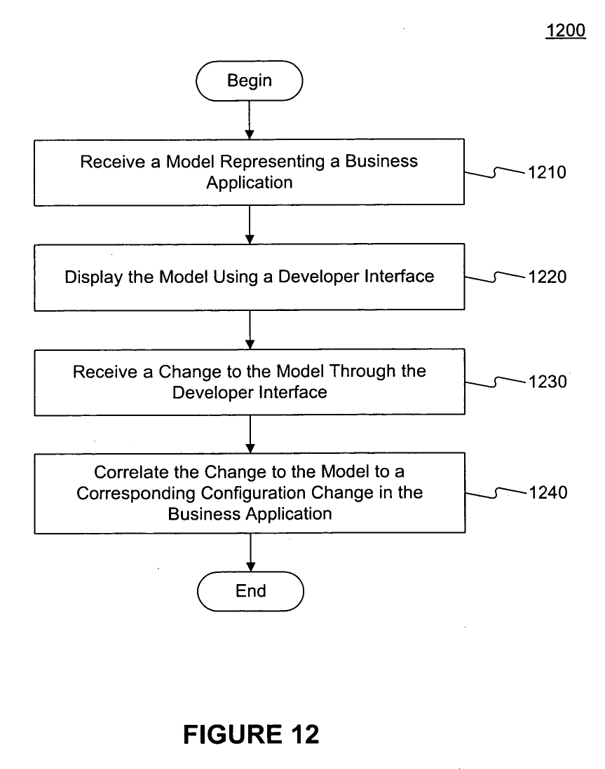

In an embodiment of the present invention shown in FIG. 12, configuration of a business application is analyzed by receiving a model representing the business application and displaying the model using a developer interface. When a change to the model is received through the developer interface, the change to the model is correlated to a corresponding configuration change in the business application. The corresponding configuration change may be applied to the business application or it may simply be used to model possible changes.

### XI. Checking Validity of Business Applications

Business applications often involve large, complex legacy systems. Over time, these systems evolve to accommodate changing business rules, user needs, etc. Each change to a business application may affect many logic entities within the business application. Furthermore, changes to the business application can make an already complex system even more difficult to maintain. These difficulties are compounded by the fact that table-based business applications do not allow the use of design and optimization techniques available in other types of systems.

For example, changing a processing rule may result in another logic entity, such as configuration data, being inconsistent with underlying business logic. However, because business applications are large and complex, the user making the change may be unaware that the logic entity now contains a logic structure error. Traditional table-based business applications do not have a mechanism for identifying or optimizing inconsistencies in underlying business logic. Thus, many problems, such as broken or circular links in logic entities, may be undetected in the business application.

A number of well-known programming techniques may be used to optimize the design of existing software code without altering the code's behavior. For example, a software debugger, such as Validity Check, True Time, or Bounce Checker may improve code by testing it and modifying the values of variables where necessary. Optimized code is generally easier to read and understand and more efficient to maintain.

Methods and systems consistent with the present invention enable the use of known software tools, such as debuggers, to optimize the configuration of a business application by eliminating inconsistencies in underlying business logic of the business application. In one embodiment, each logic entity in a business application may be transformed into a corresponding object-oriented structure. An object-oriented language tool, such as a compiler, may then be used to check the structural consistency of the object-oriented structures and flag identified logic structure errors. Although the object-oriented language tool literally identifies problems, such as broken links, in object-oriented code, it also identifies problems in the underlying logic of a business application because the code models the business application. For example, an object-oriented compiler may identify a circular reference within a branch of code. By correlating that branch of code with its corresponding logic entity in the business application, the inconsistent logic entity may be identified. In one embodiment, inconsistent logic entities in the business application may be corrected after they have been identified using the object-oriented model, and the model translated back into business application entities that will function in the business application system.

For example, a debugging tool will optimize the object-oriented structures, for example, by “repairing” circular links. However, the operation of the code will not be affected. Once correction of identified logic structure errors in the object-oriented code is completed, the object-oriented code may be translated into corresponding business application logic structures. As a result, the business application will reflect the improvements made by optimizing the object-oriented code.

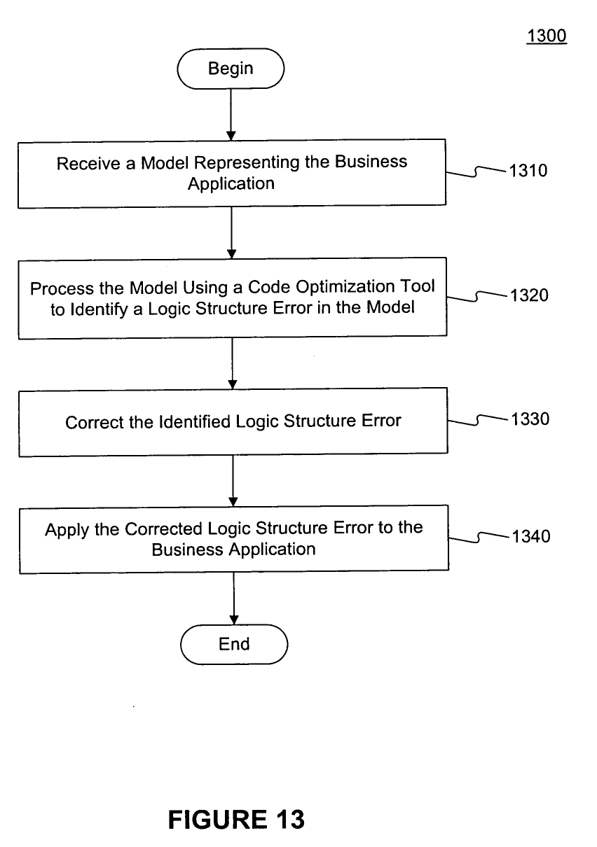

In one method consistent with the present invention shown in FIG. 13, a business application composed in a first programming format is analyzed by receiving a model representing the business application in a second programming format and processing the model by using a code optimization tool to identify logic structure errors. Identified logic structure errors are corrected and applied in the first programming format, to the business application.

### XII. Using CASE Tools to Verify Business Application

Business applications often involve large and very complex table-based systems. To configure and implement a business application, a company may need to employ highly trained consultants. Due to the complexity of traditional business applications, it may take years to configure an application for a single company. Business applications typically have limited range of development tools to assist in development of the business applications configuration.

Computer-aided software engineering (CASE) tools assist a software developer in developing and maintaining software code. CASE tools enable users to design and manipulate code, such as object-oriented code, in an easy-to-understand manner. For example, CASE-tool-generated diagrams representing business application layers may assist an architect of a business application in visualizing a matrix of the project. As a result, the architect of a business application may more efficiently design and optimize the business process. For example, such diagrams may help a user to identify an amount of wagetypes, and how those wagetypes are related.

Systems and methods consistent with the present invention enable business application consultants to generate and analyze the structure of business applications using tools from a CASE environment. For example, a software developer may use a Modified Modeling Language (MML) tool to build a high level diagram of a logic entity, such as a business object class.

By transforming business application structures into object-oriented structures, object-oriented CASE tools may be applied to generate similar business application structures. For example, a user can write a new business rule using familiar object-oriented code, and that code may be converted into logic business entities to apply the new rule in the business application. As a result, users may configure the business application without worrying about its native format or structure.

In some embodiments, when business application structures are displayed using object-oriented code structures, the business meaning of the object-oriented code structures may also be displayed. This aids the user in understanding a complex business application in the format of familiar, easy-to-understand object-oriented programming constructs.

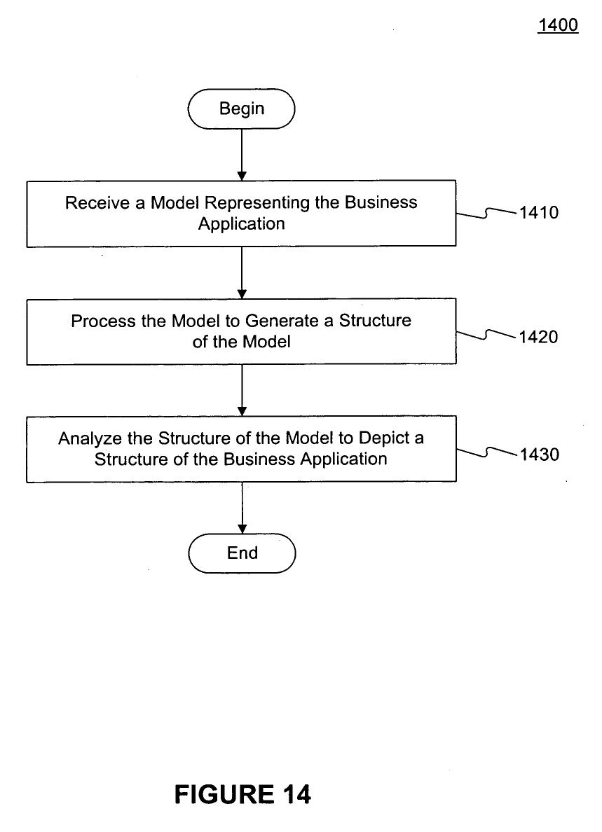

In an embodiment consistent with the present invention shown in FIG. 14, a business application composed in a first programming format is analyzed by receiving a model representing the business application in a second programming format and processing that model to generate its structure, including, for example, the structure of the business application configuration data and rules. In another example, processing may include generating a diagram of the model's object classes. Further analyzing the structure of the model may be performed by depicting a structure of the business application.

### XIII. Comparing And Merging Business Applications

Business applications often involve large and very complex legacy systems. Over time, these systems evolve to accommodate software updates fixing technical glitches or improving the usability or the performance of the previous business application versions, such as patches; changing business rules; user needs; etc. For example, changing tax laws in one of the countries in a payroll business application may require change of a business rule. Each change to a business application may affect many logic entities within the business application changing an outcome, for example, an amount of calculated payroll.

Traditional table-based business applications do not have any simple mechanism for identifying changes between their different versions. A user attempting to compare two different versions of a business application and identify, for example, different tables or differences in a code, would have to compare each business rule separately, one by one. Because the business application is large and complex, this process may be extremely time consuming and require a user with extensive training.

Methods and systems consistent with the present invention allow a user to compare different versions of a business application using an object-oriented model of the business application. By transforming business application structures into object-oriented structures, such as object-oriented language constructs, individual differences between versions of the business applications may be identified and displayed to a user, for example, on a user interface.

To aid users in subsequent identifying differences between different versions of the business applications, all the previous versions of the business application may be stored a separate database, such as a configuration control database like CVS. Each version of a business application may be stored in a configuration control database as a transformed corresponding object-oriented structure.

Using methods and systems consistent with the present invention, to compare an updated version of the business method application with its previous versions, a user may extract the latest controlled version of an object oriented model of the application from a configuration control database. Then, a user may extract the latest deployed version of a business application from a server database containing the deployed version of the business application, including recent updates, such as, for example, patches. The extracted deployed version may be transformed into a corresponding object-oriented structure. Finally, the user may extract a version of the business application including user-made current changes from the user's storage space. The object-oriented models of the business application may be capable of autonomous existence from the business application. Having all three versions represented in an object-oriented structure may allow a user to perform a three-way comparison between the object-oriented structure edited by the user and two retrieved versions copied from the configuration control database and the deployed server database.

Using methods and systems consistent with the present invention, a user may automatically compare all three versions of the business application model in a visually enabled mode by, for example, selecting a “Show Changes” button. As a result, business objects, for example, wage types, that differ between three models, may be displayed on an user interface marked with an icon to show where changes have been made. In one example, an icon may be shown to highlight each change and list values of the business object before and after the change.

Comparing the object-oriented structures of the model's three different versions, object-by-object, may allow a user to identify, for example, a list of wagetypes, business rules, schemas, and other logic entities, where changes have been made. In each instance, a user may choose a value of the business object for preservation and subsequent storage as a new version of the business application model. Thus, as a result of the three-way comparison, a new version of the object-oriented structure may be created containing a user's chosen values for each business object.

When a user completes the three-way comparison and decision process, the newly created version of the object-oriented model may be transformed into a newest version of the business application. That version may also be tagged as the “latest” and forwarded to a configuration control database for storage and/or to a target business system for deployment.

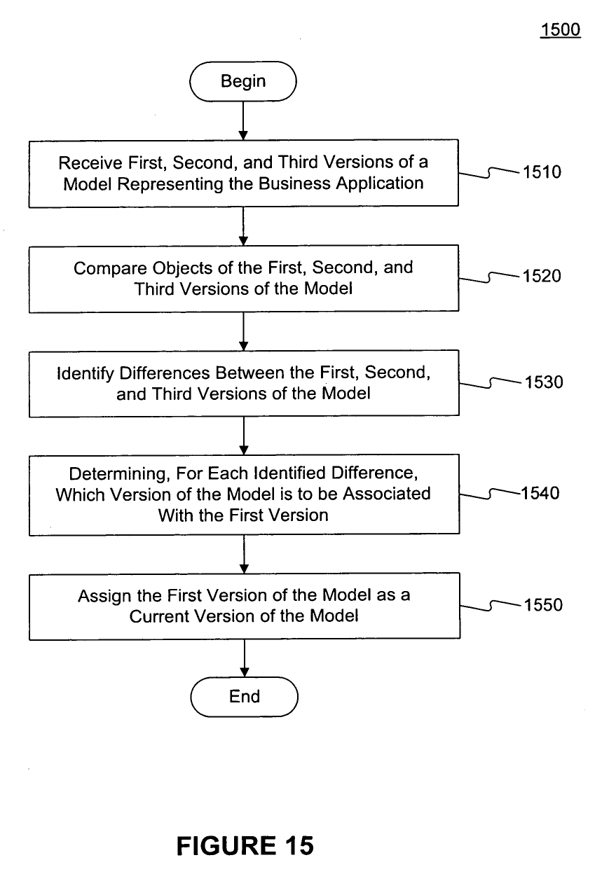

In an embodiment of a method consistent with the present invention shown in FIG. 15, a current version of a business application is determined by receiving a first, a second, and a third versions of an object-oriented programming model representing the business application, and comparing the objects of the first, the second, and the third versions of the object-oriented programming model by identifying differences between those versions. For each identified difference, a determination is made as to which version of the object-oriented programming construct will be associated with the first version of the object-oriented model. Then, the first version of the object-oriented programming construct is assigned as a current version of the object-oriented programming construct.

### XIV. User Interface

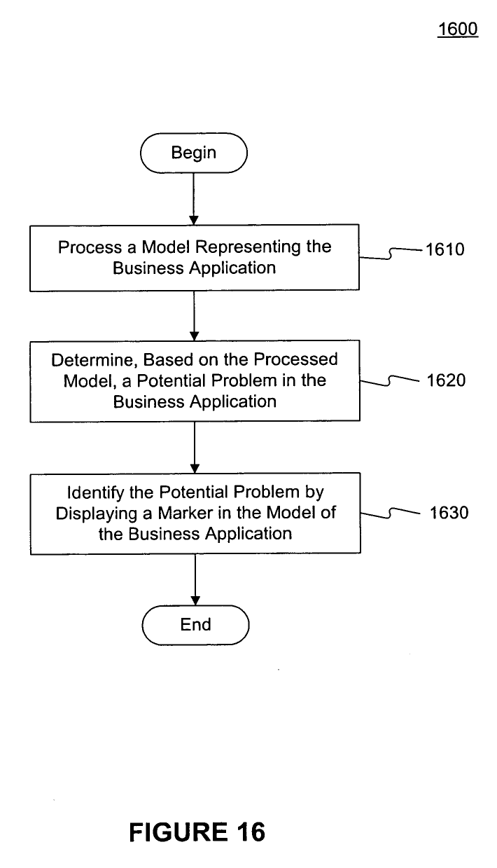

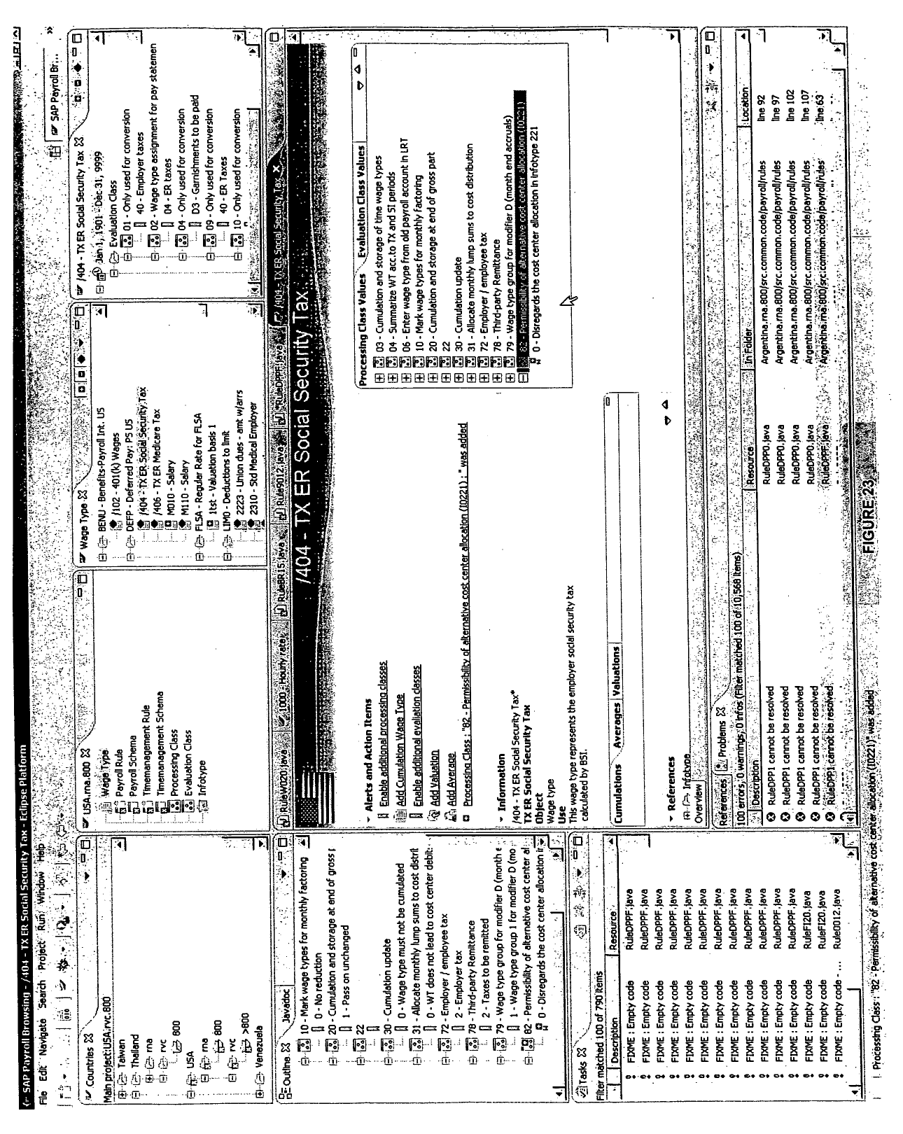

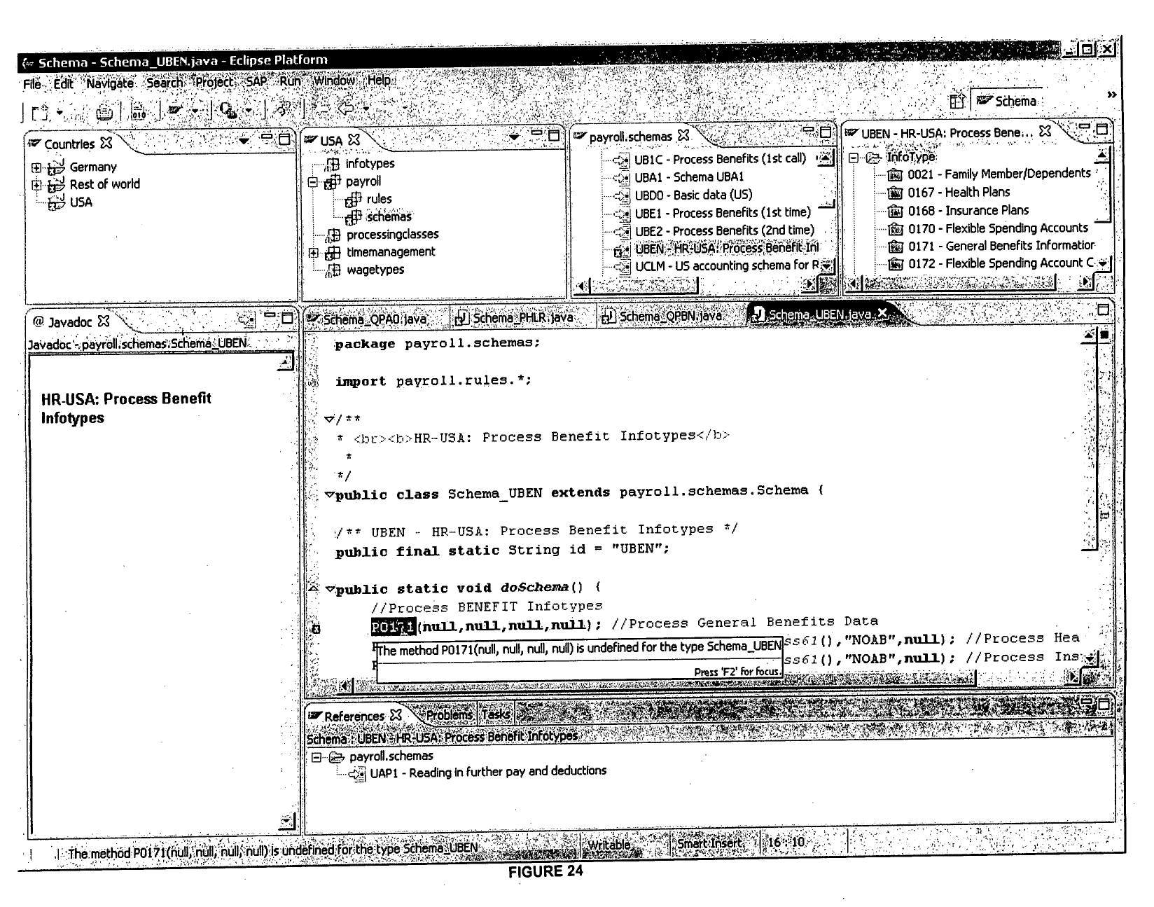

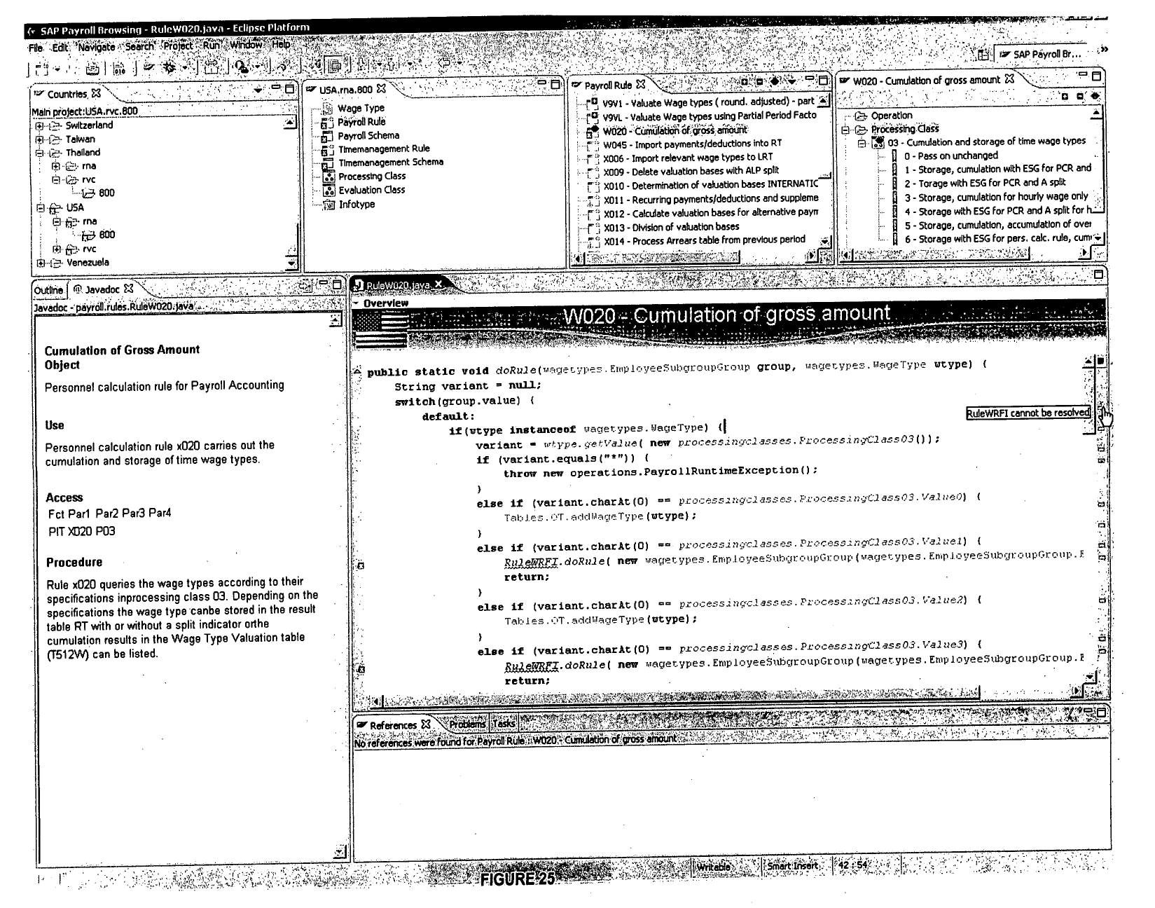

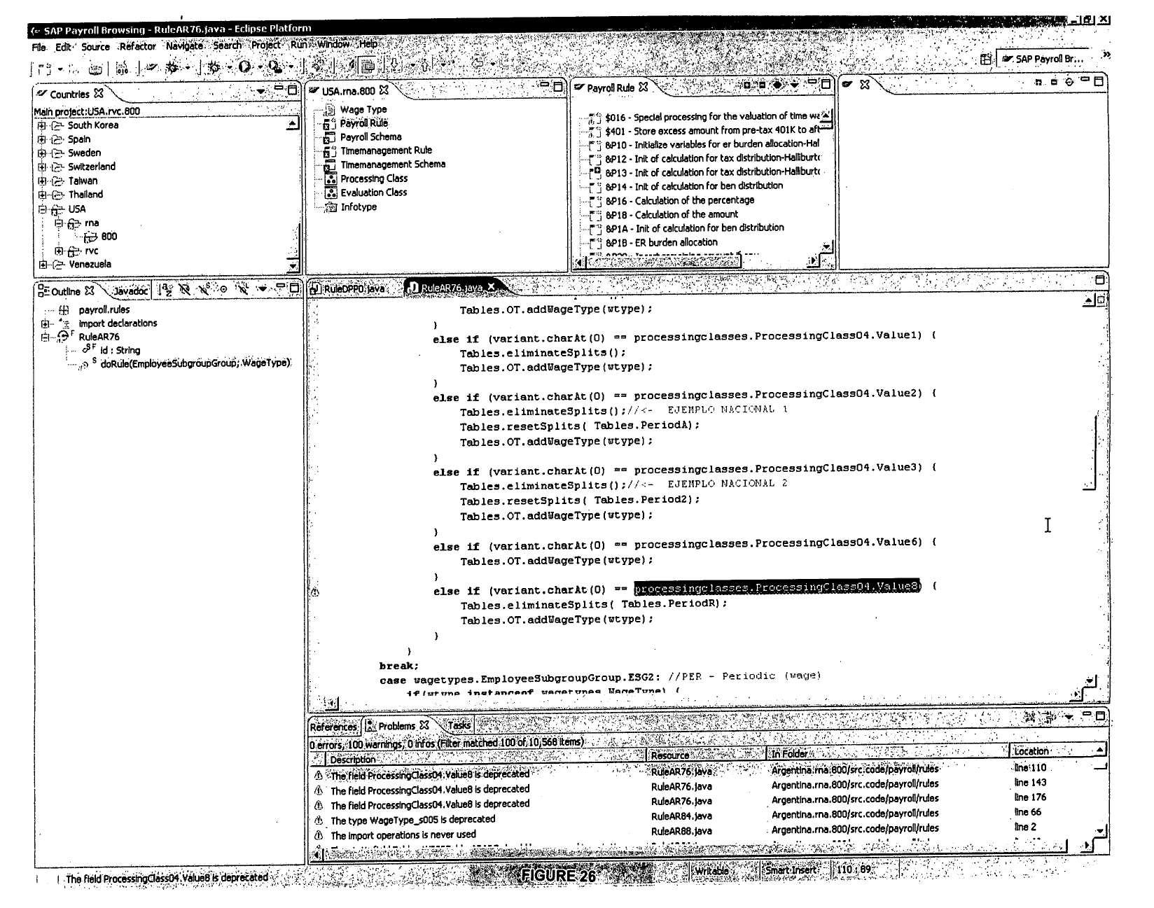

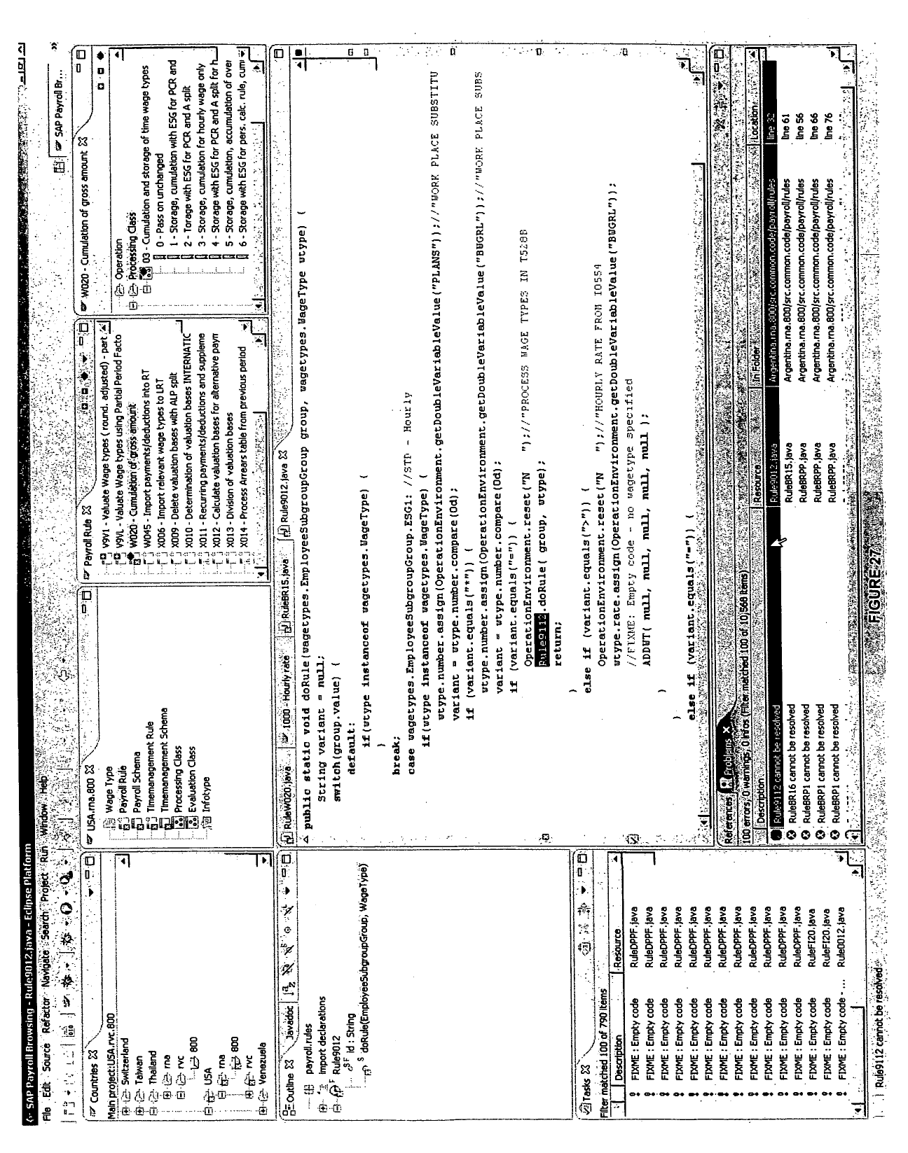

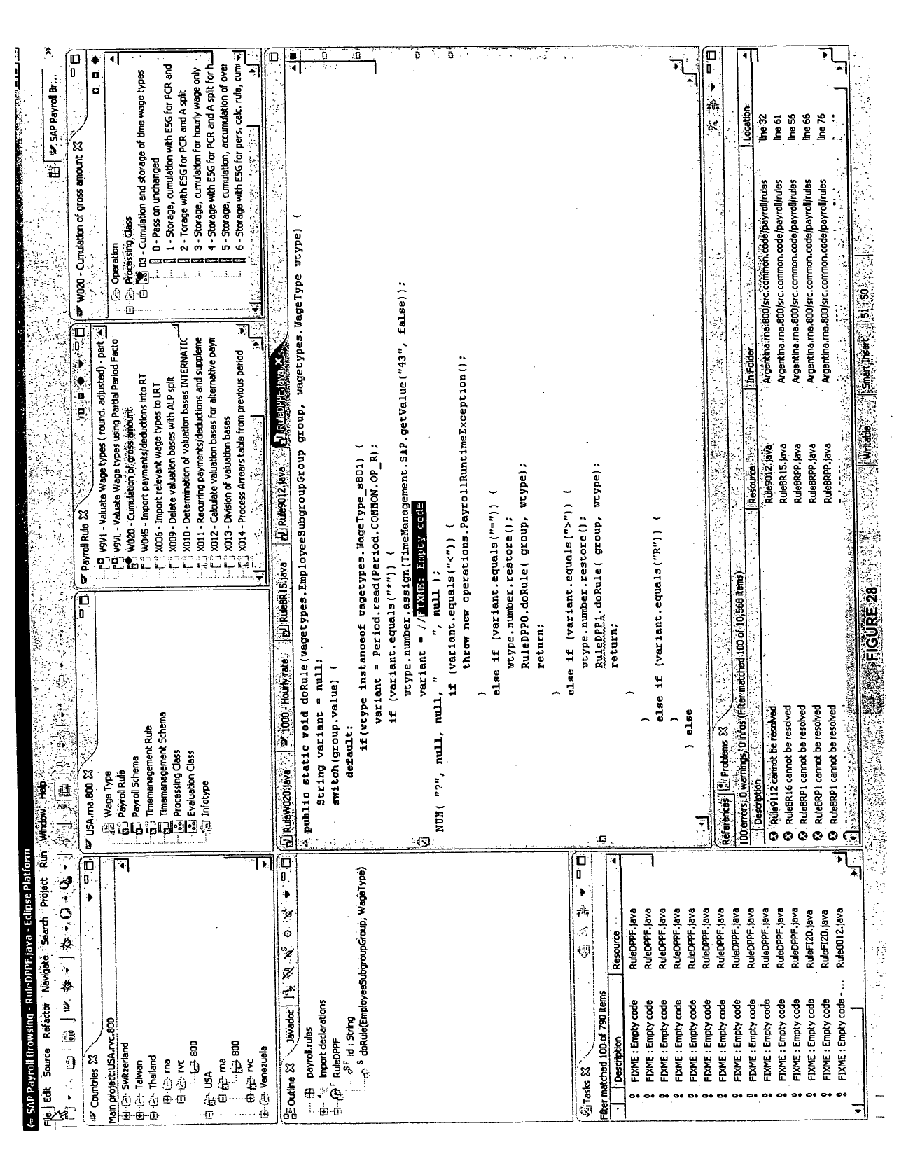

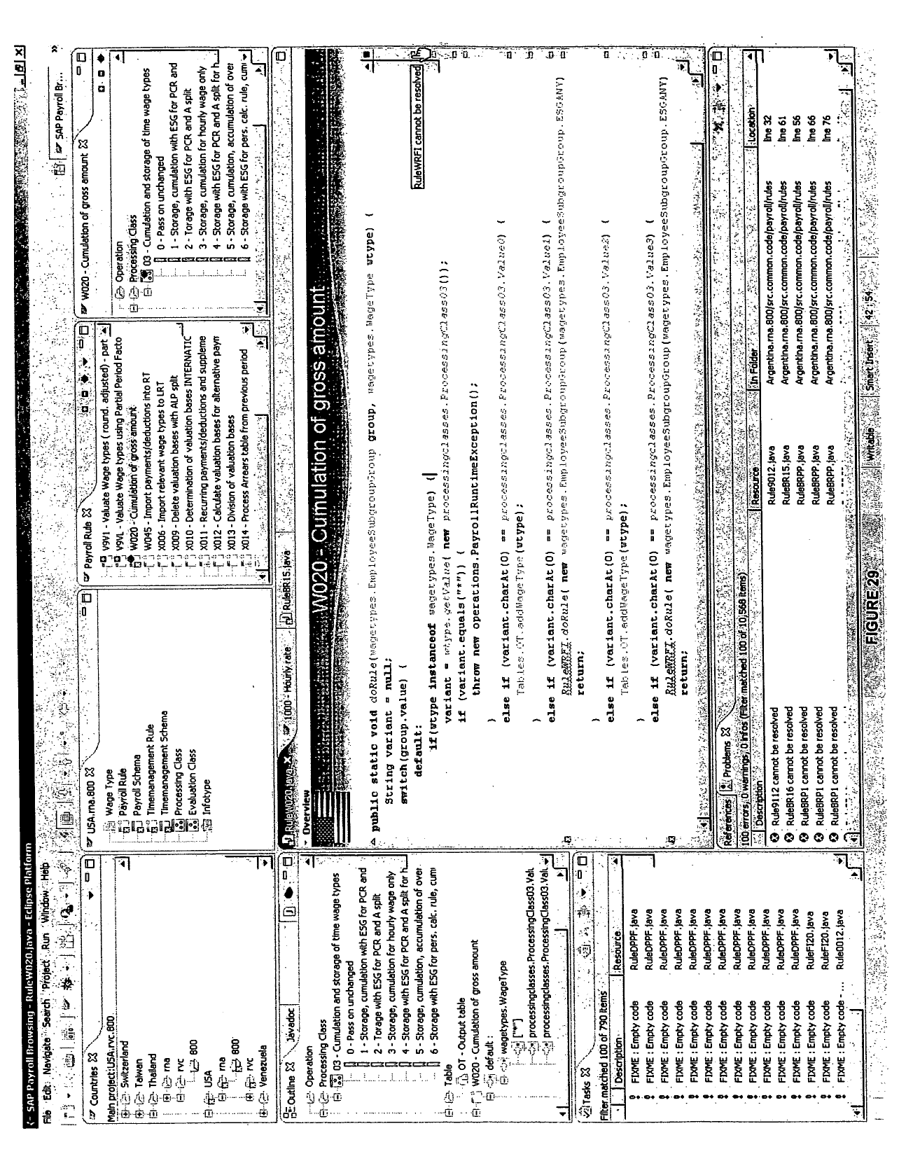

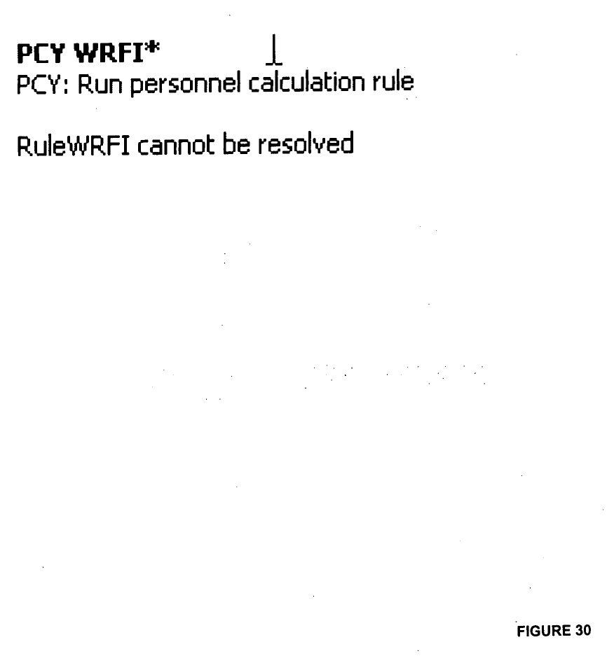

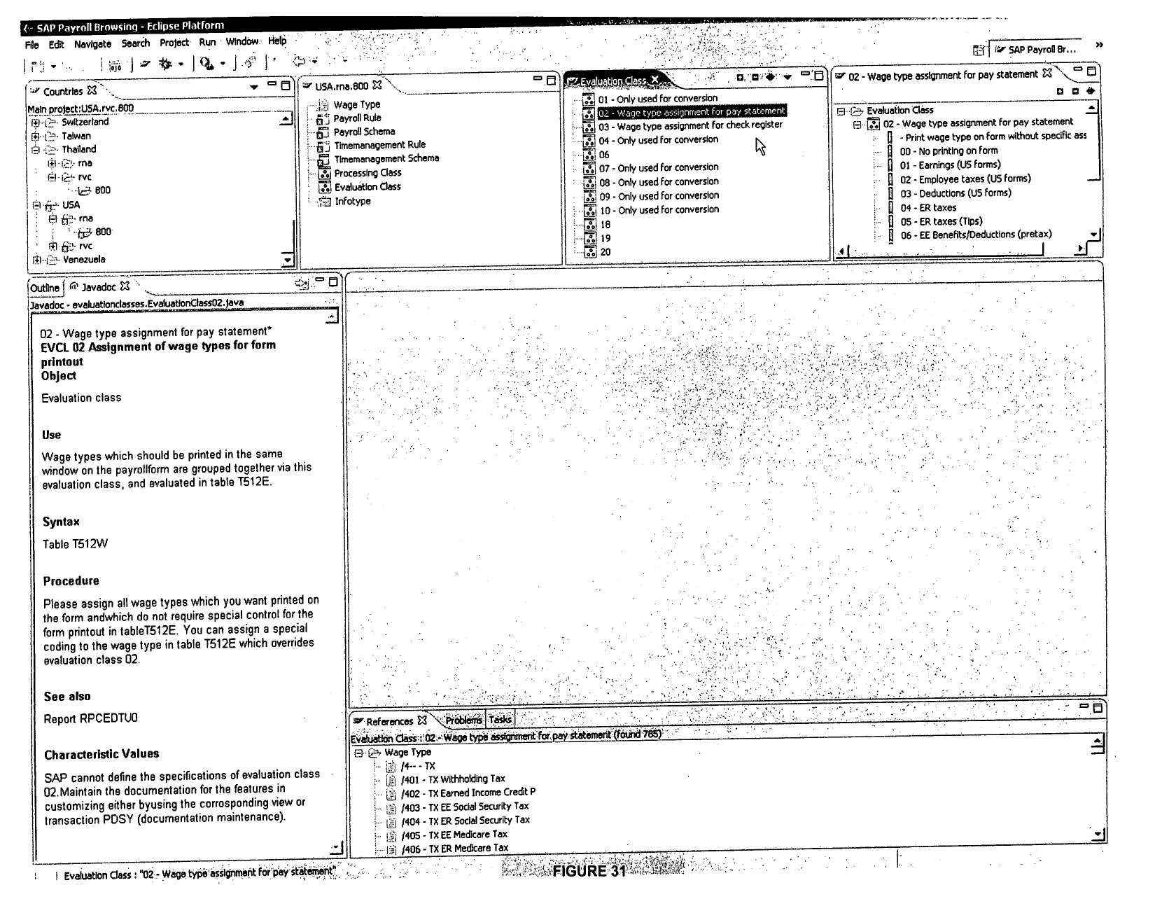

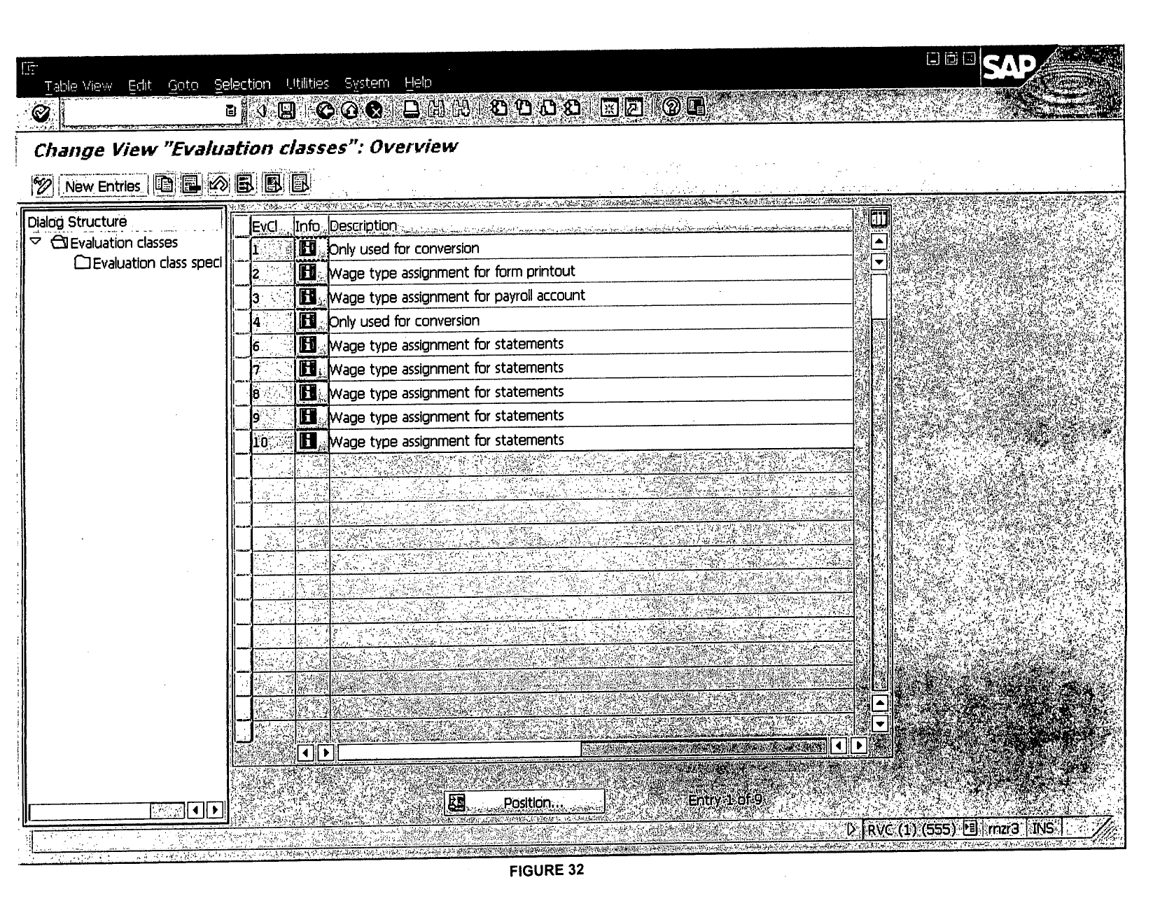

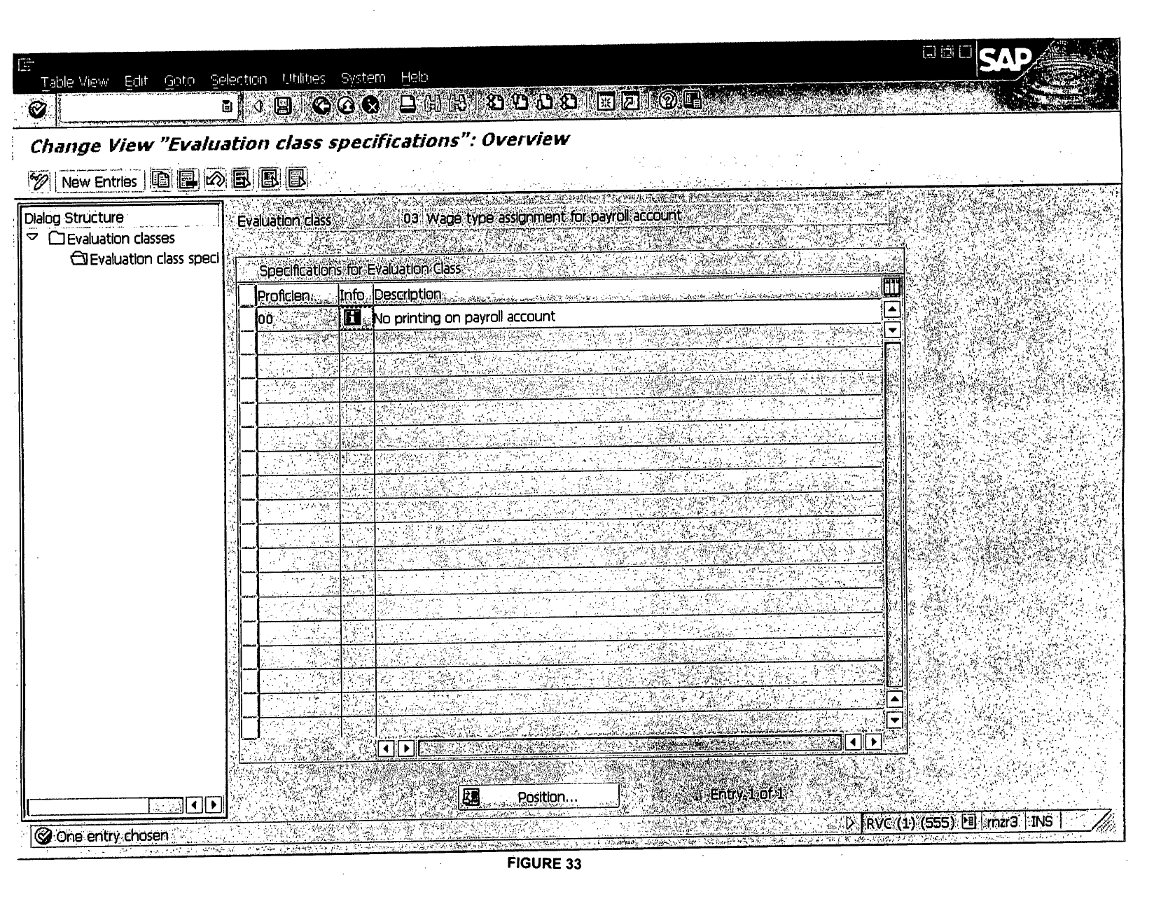

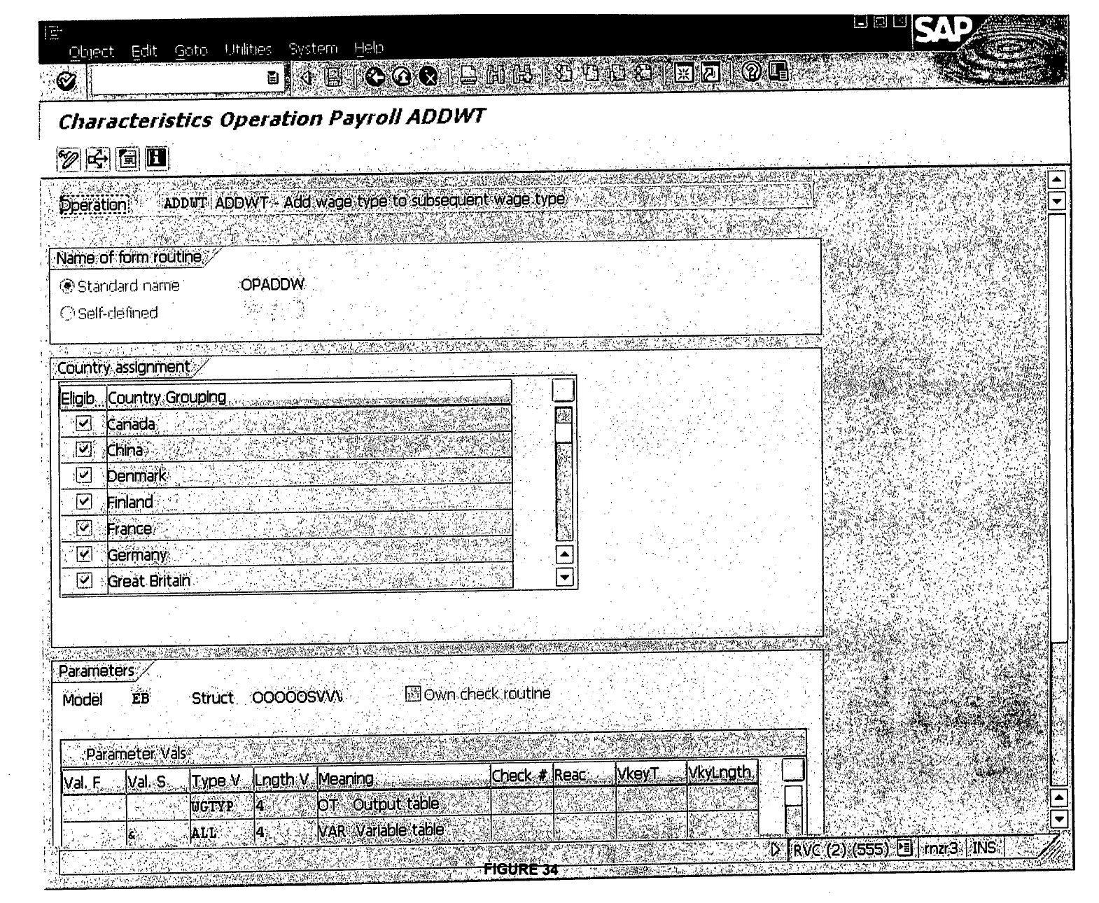

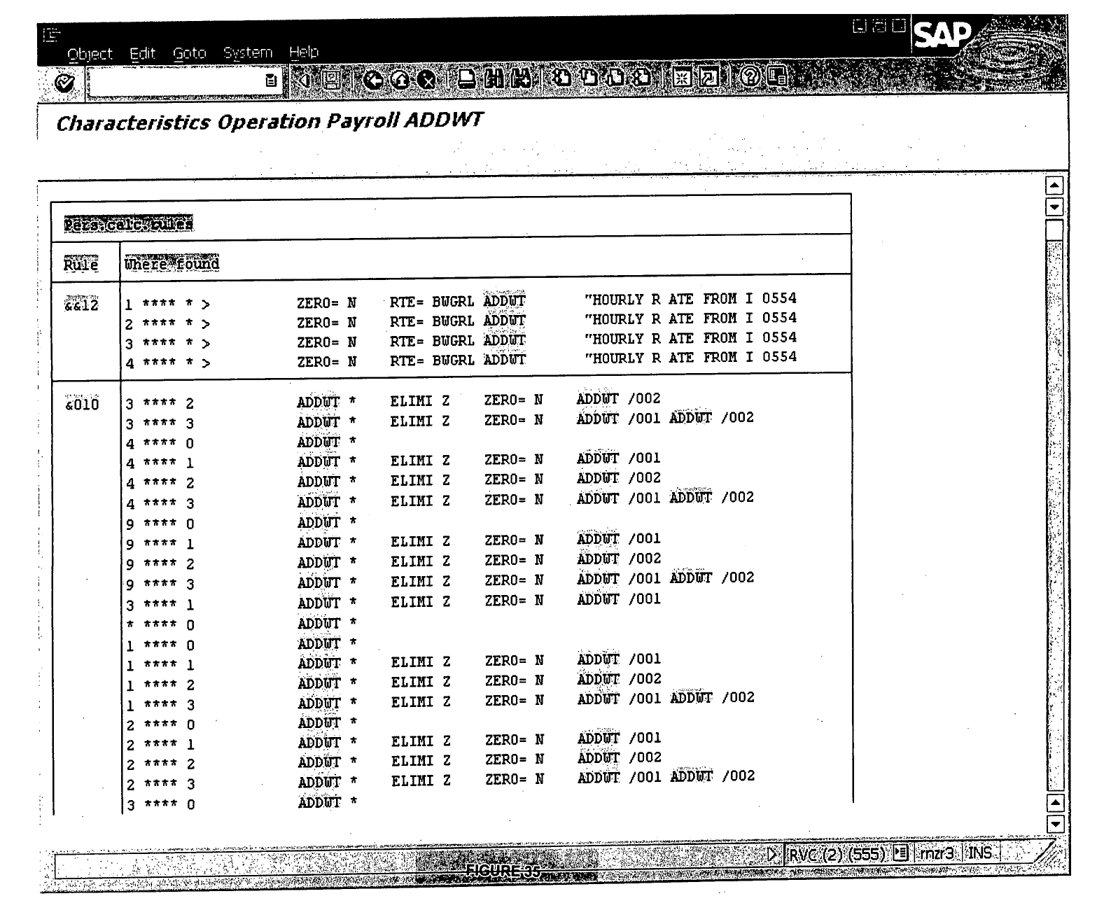

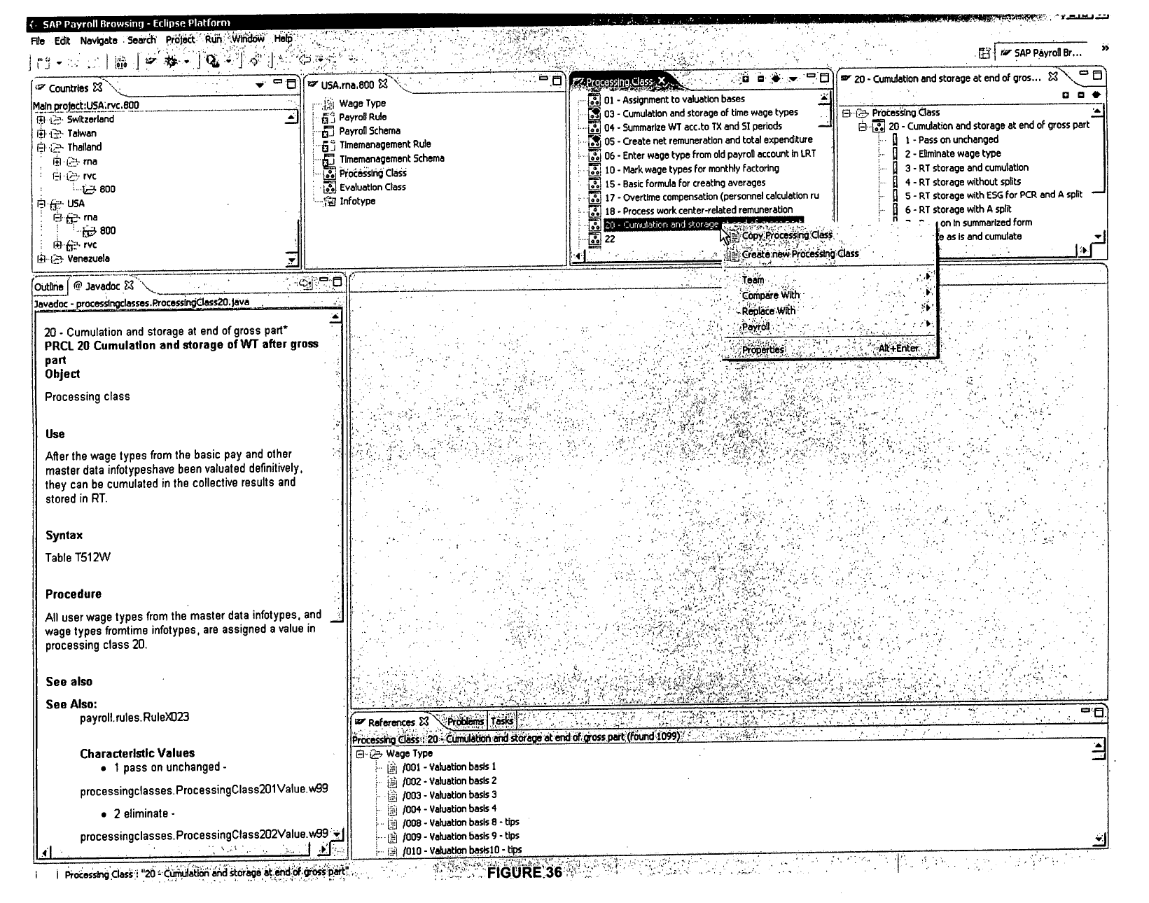

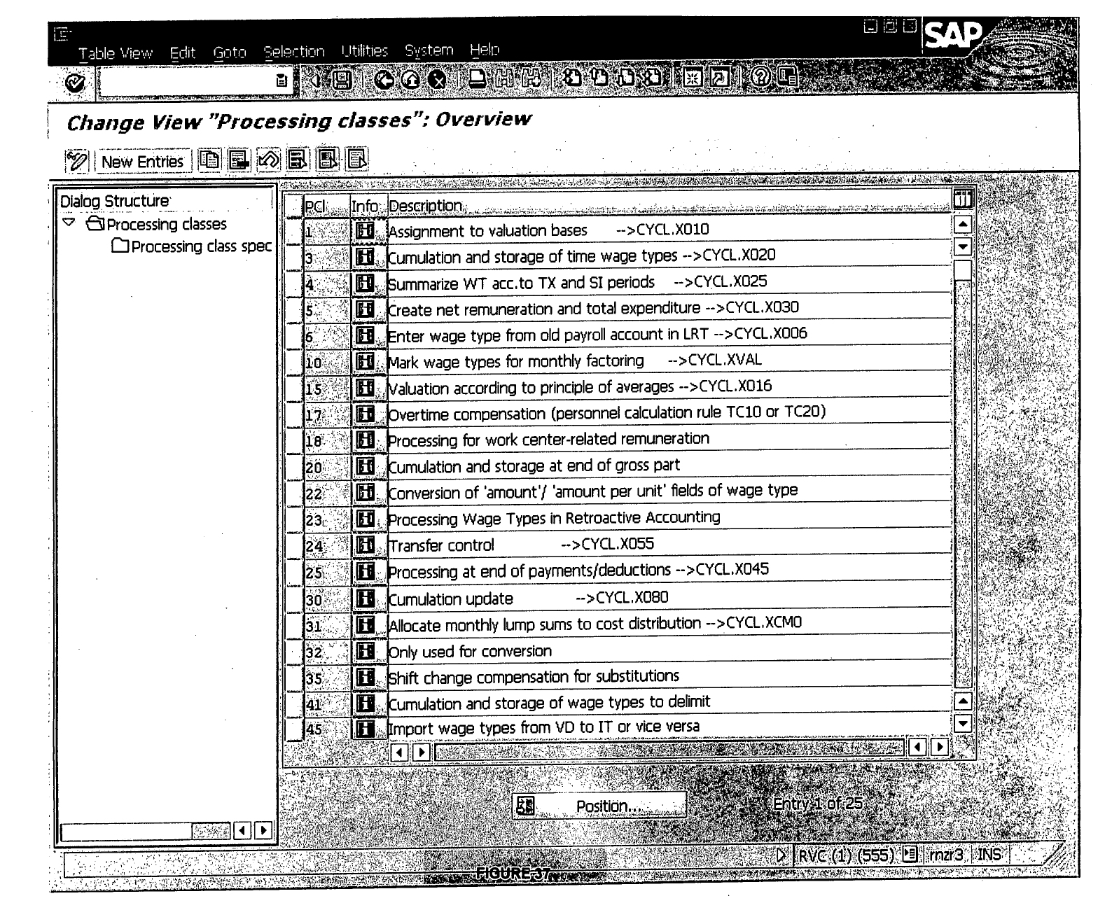

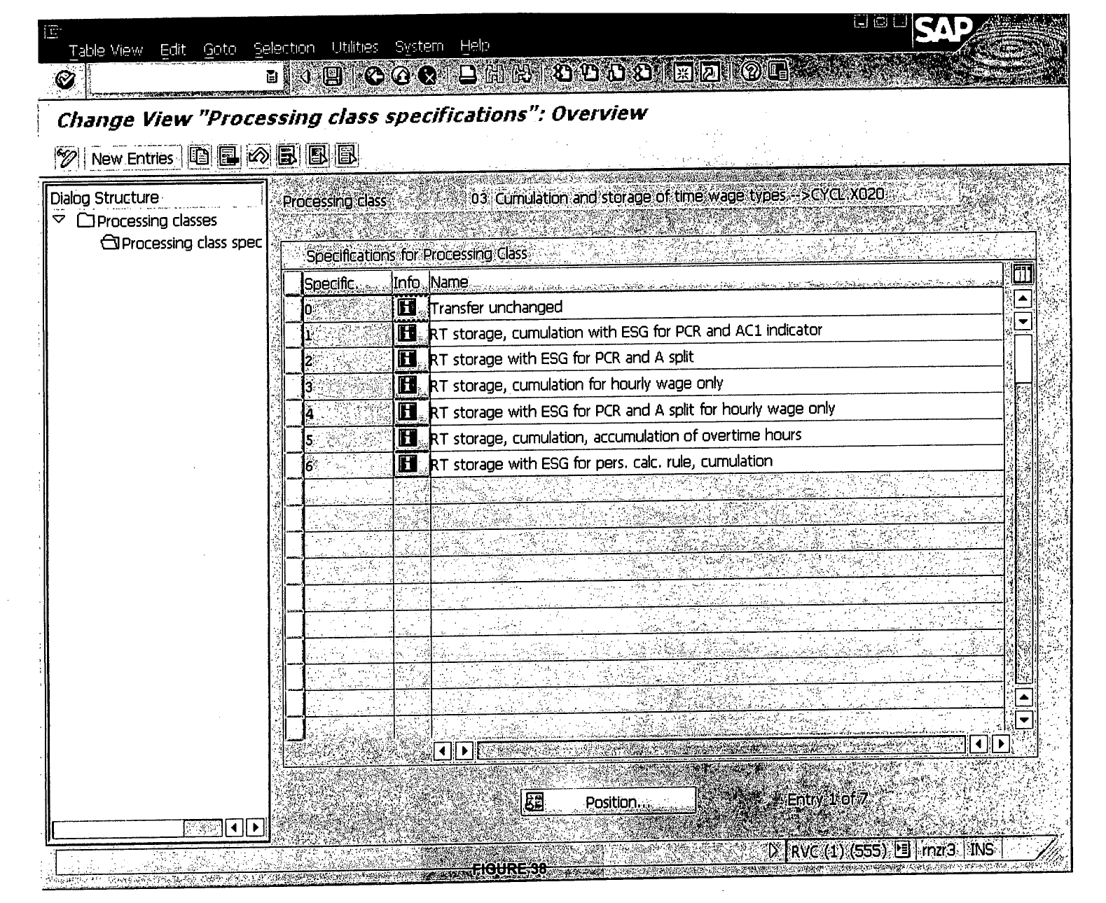

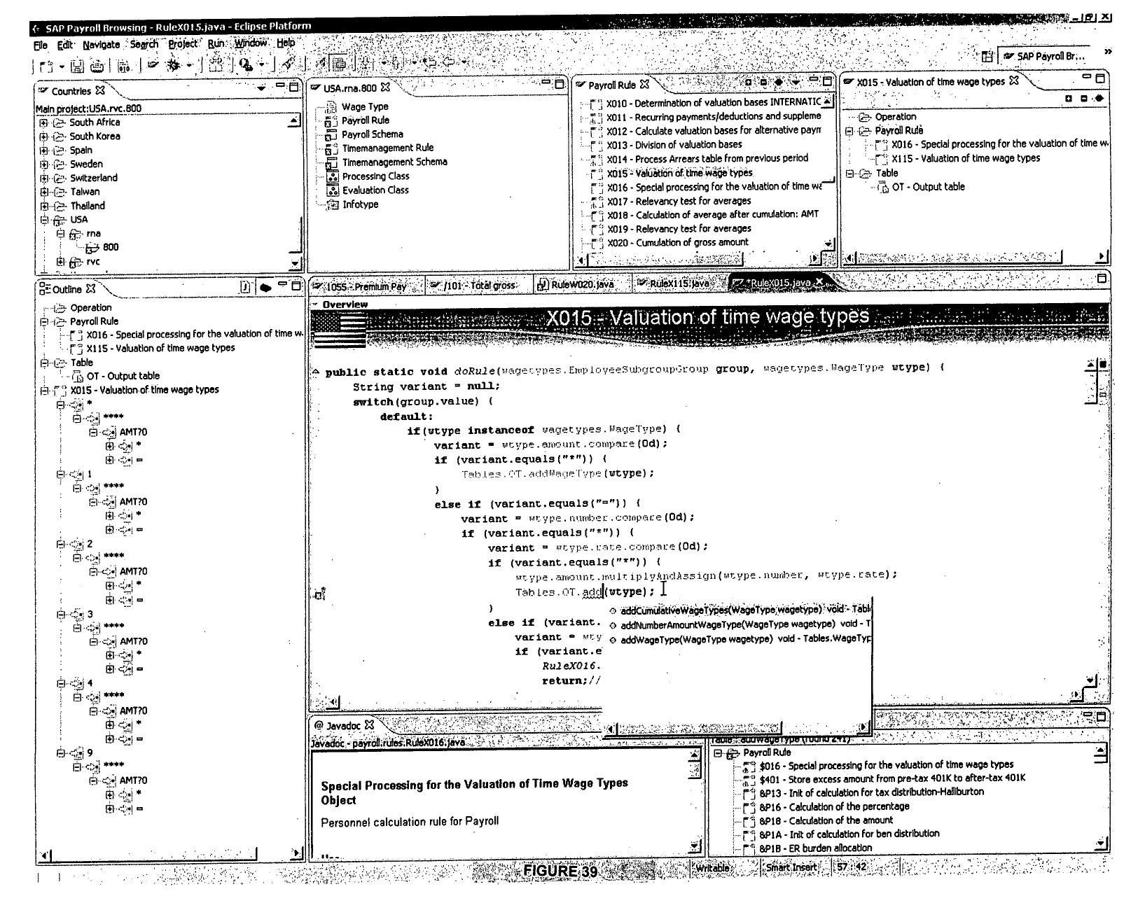

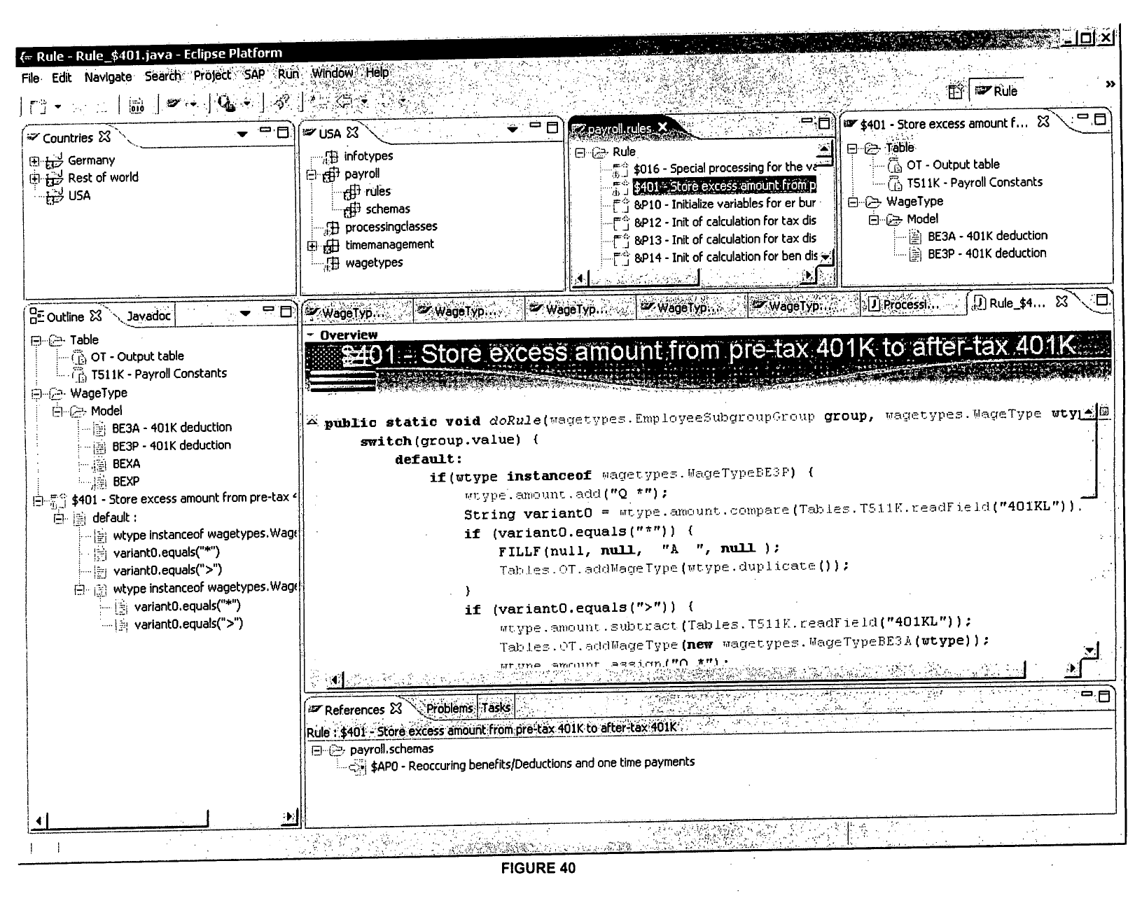

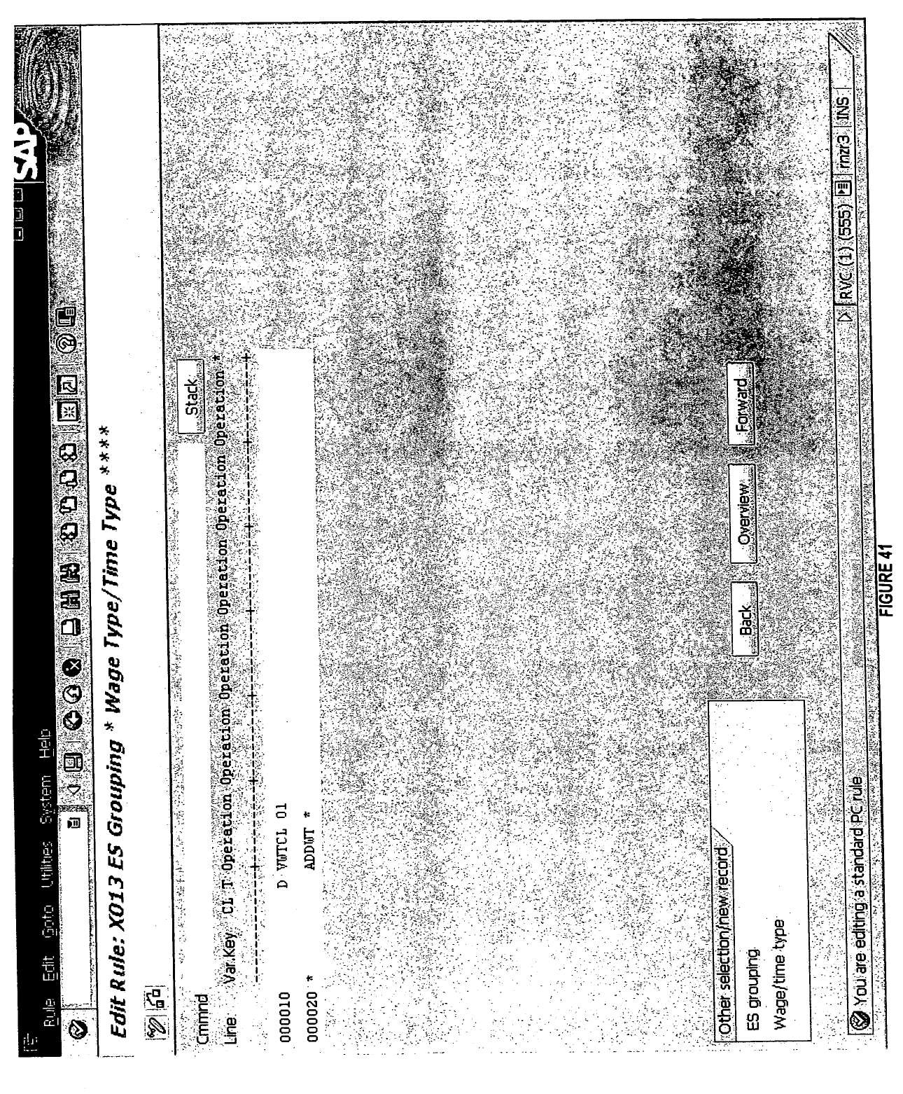

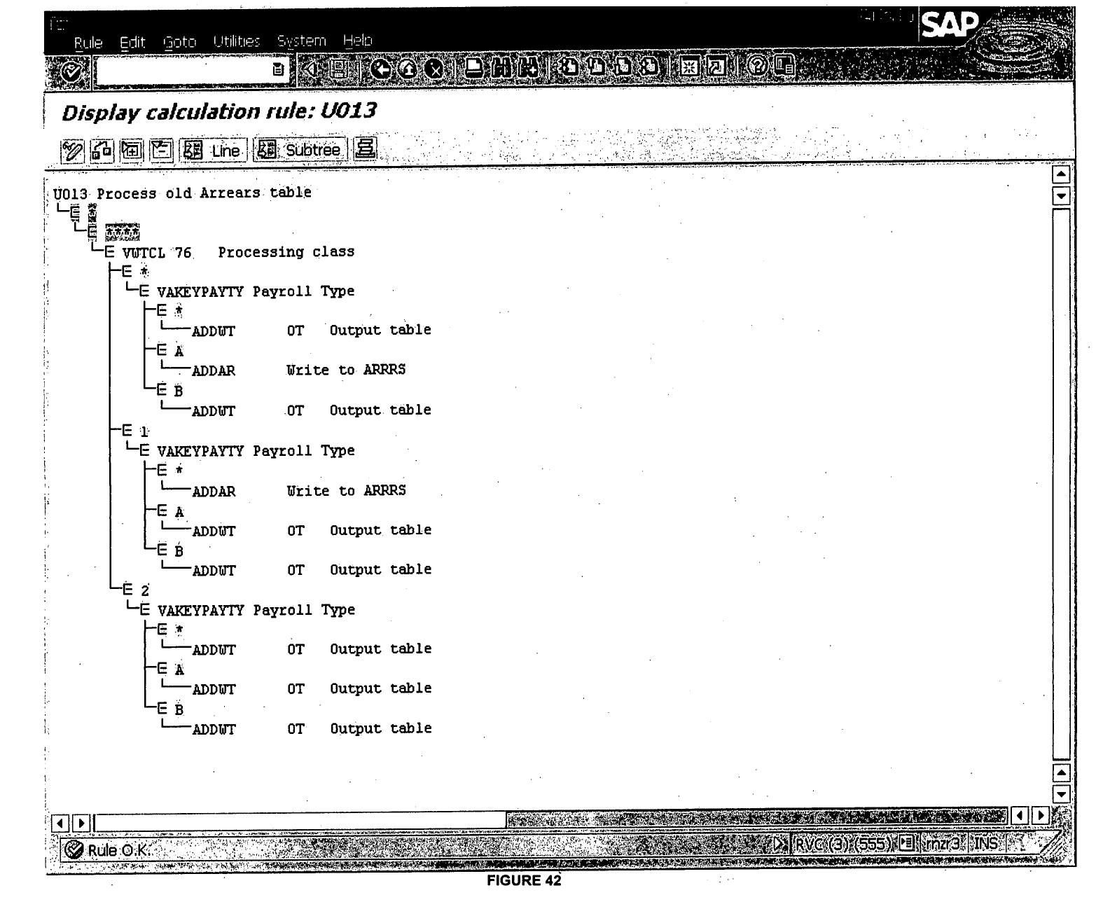

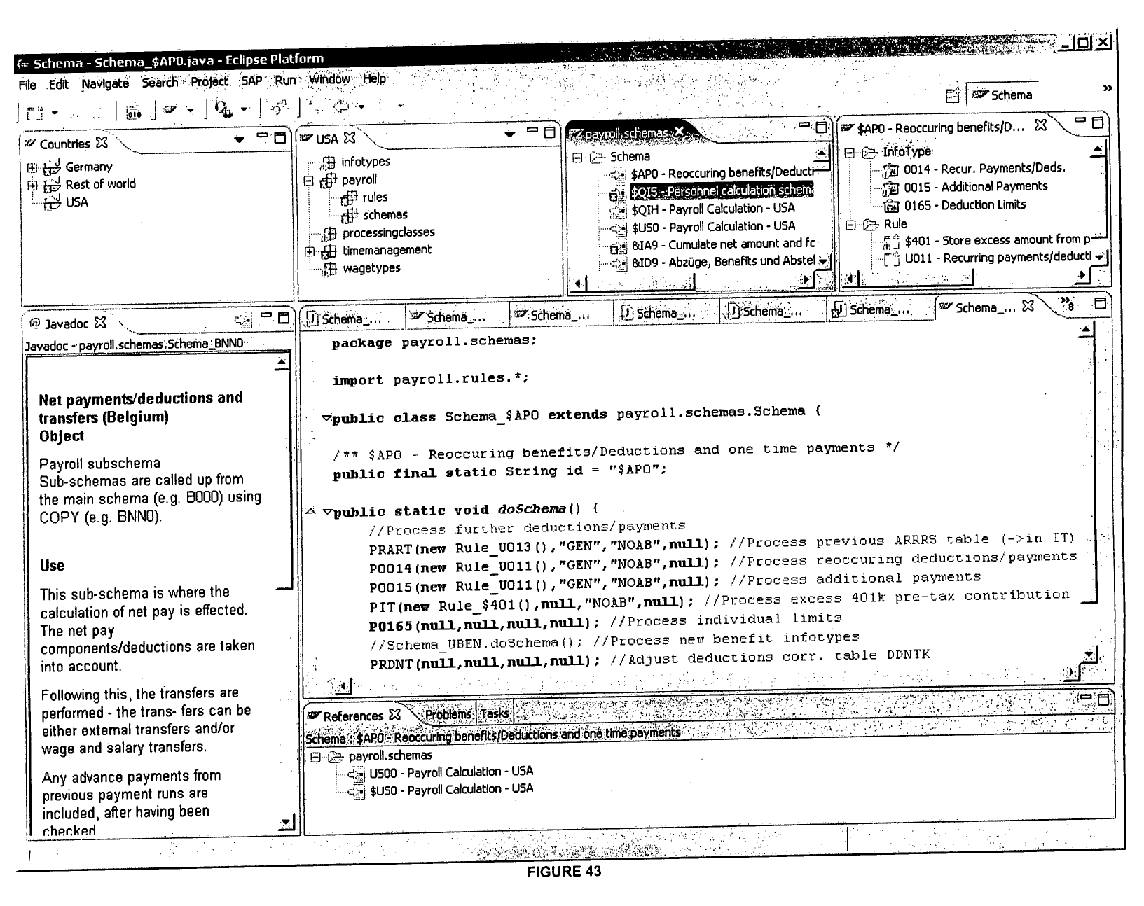

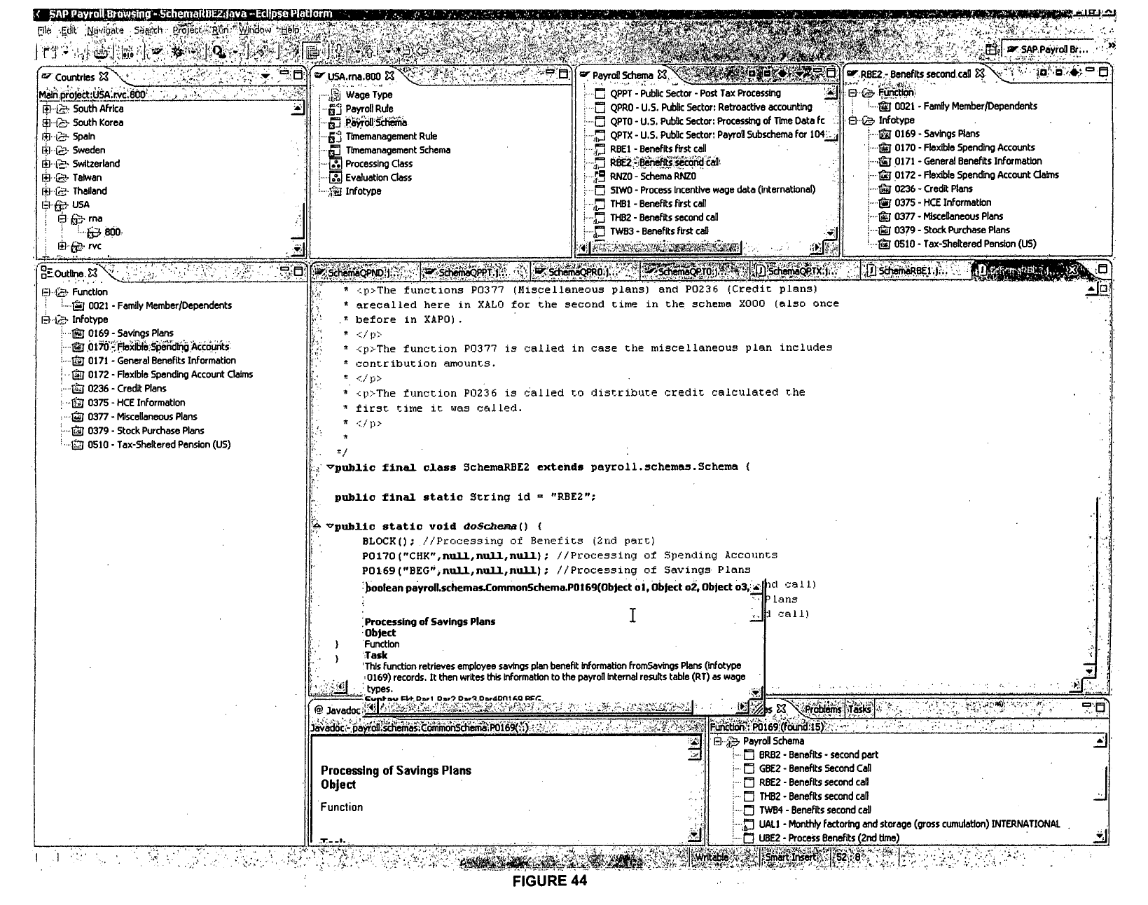

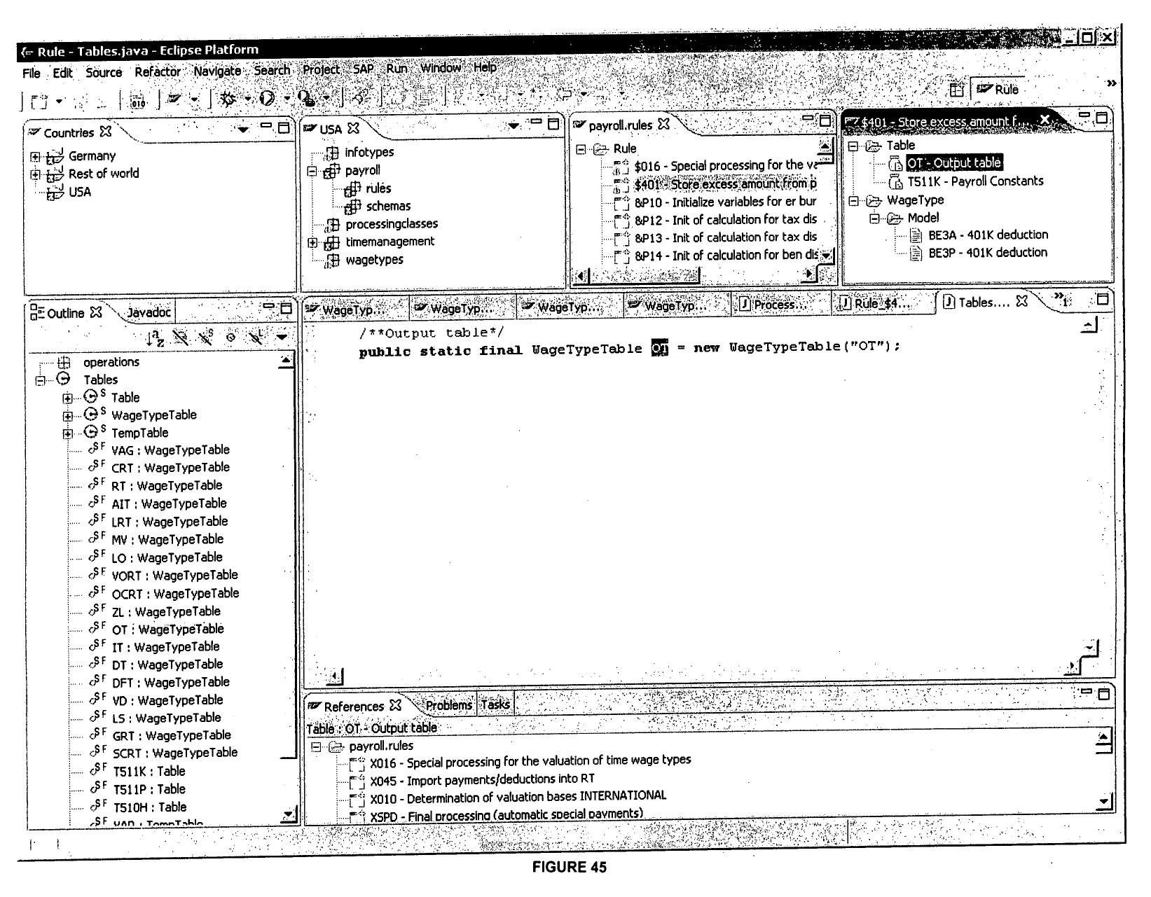

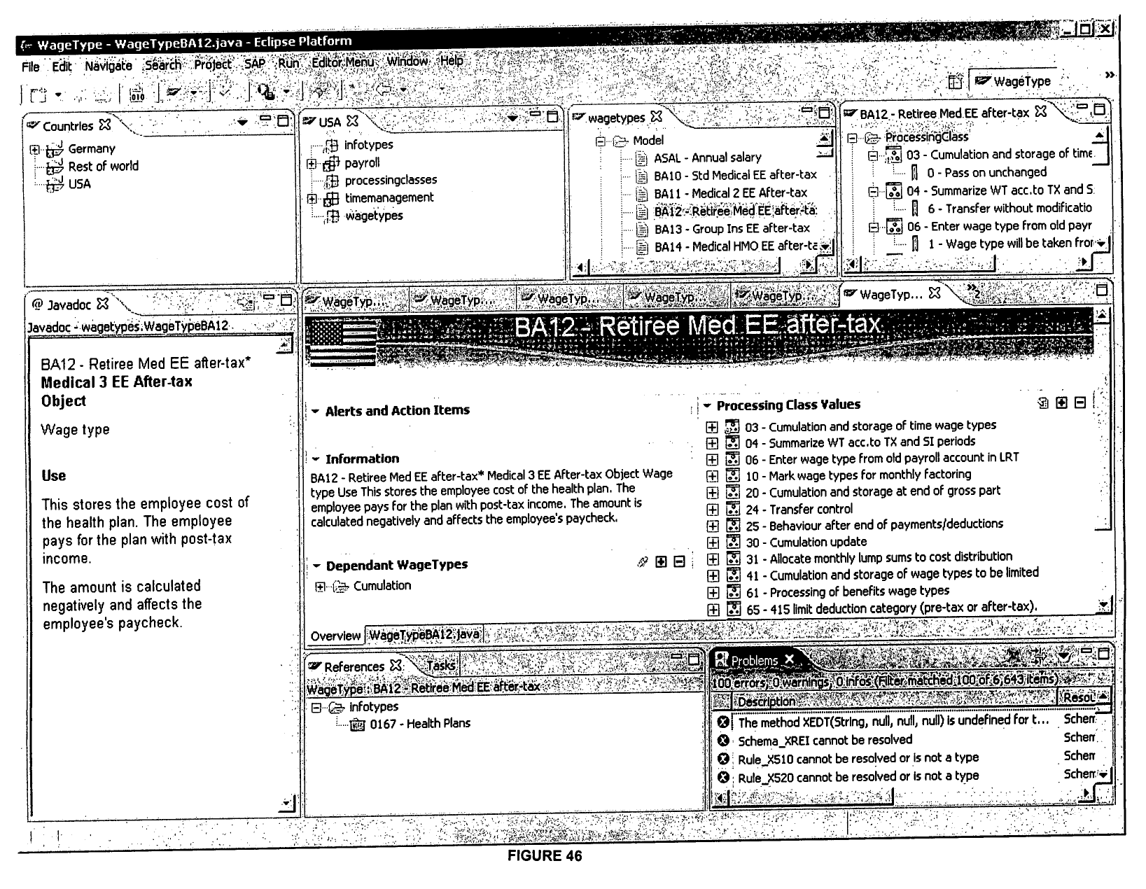

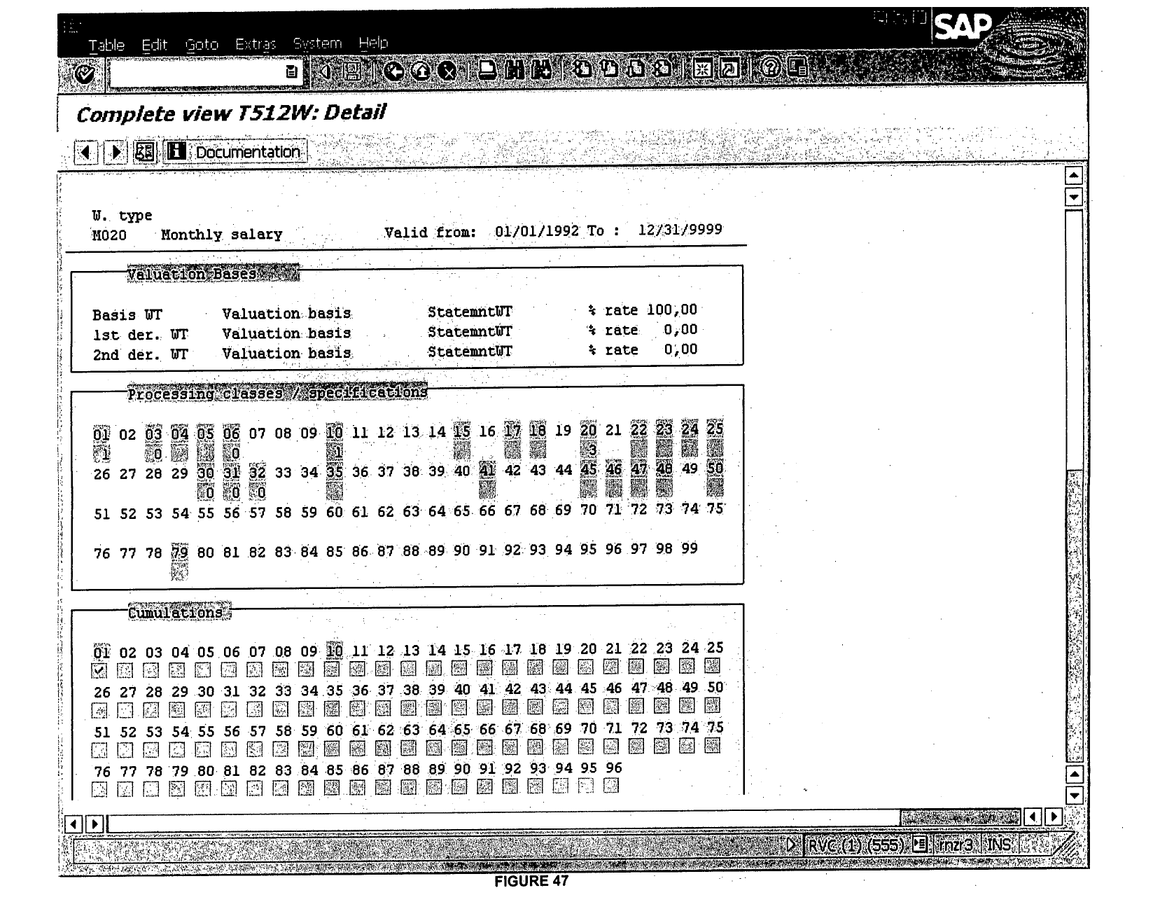

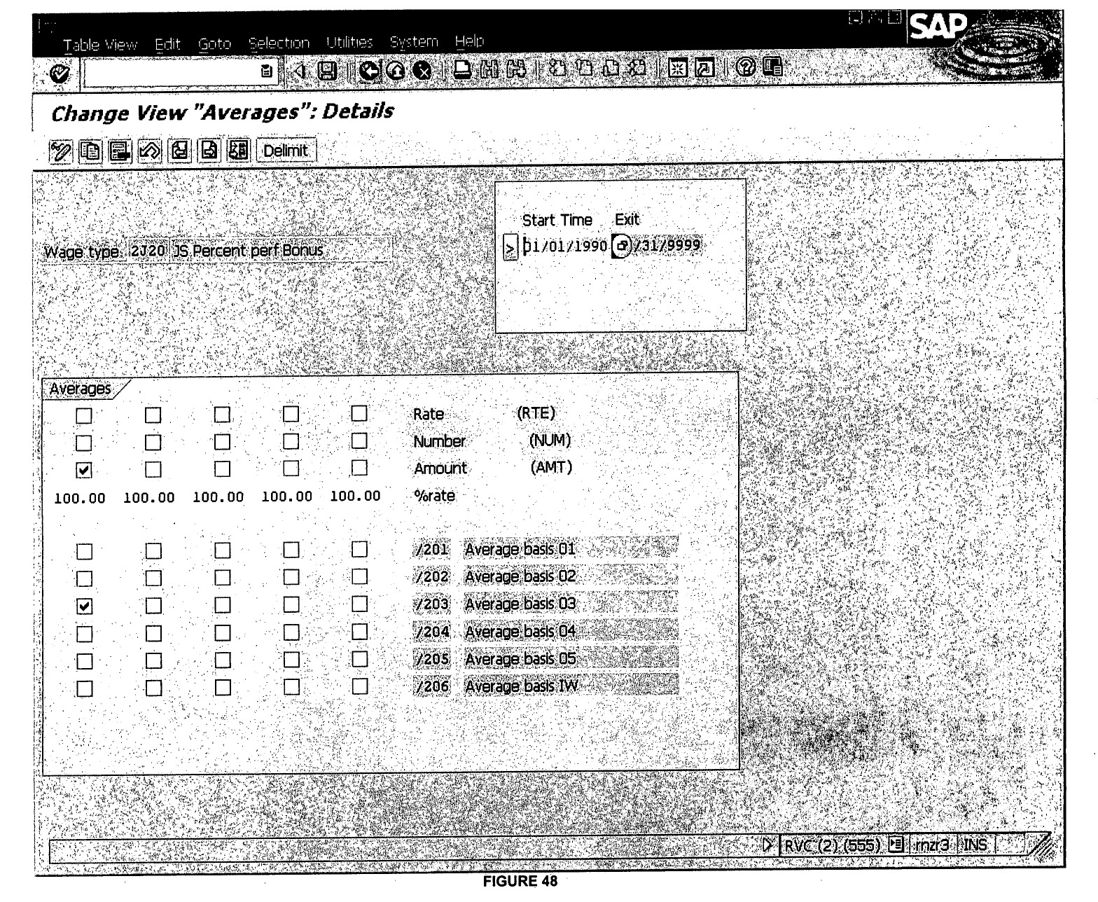

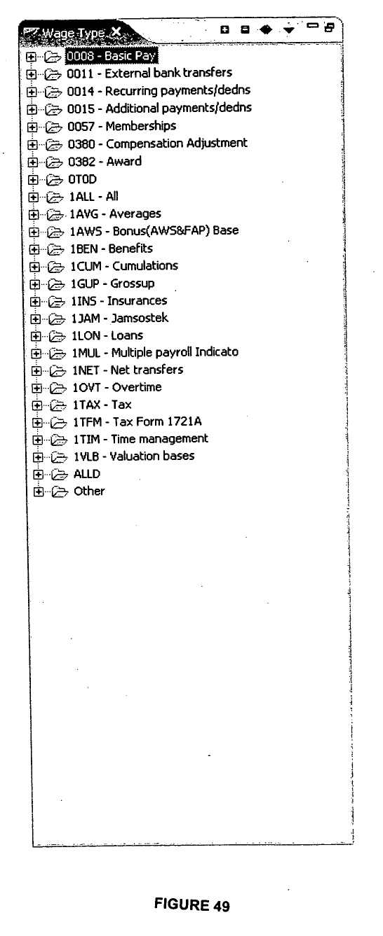

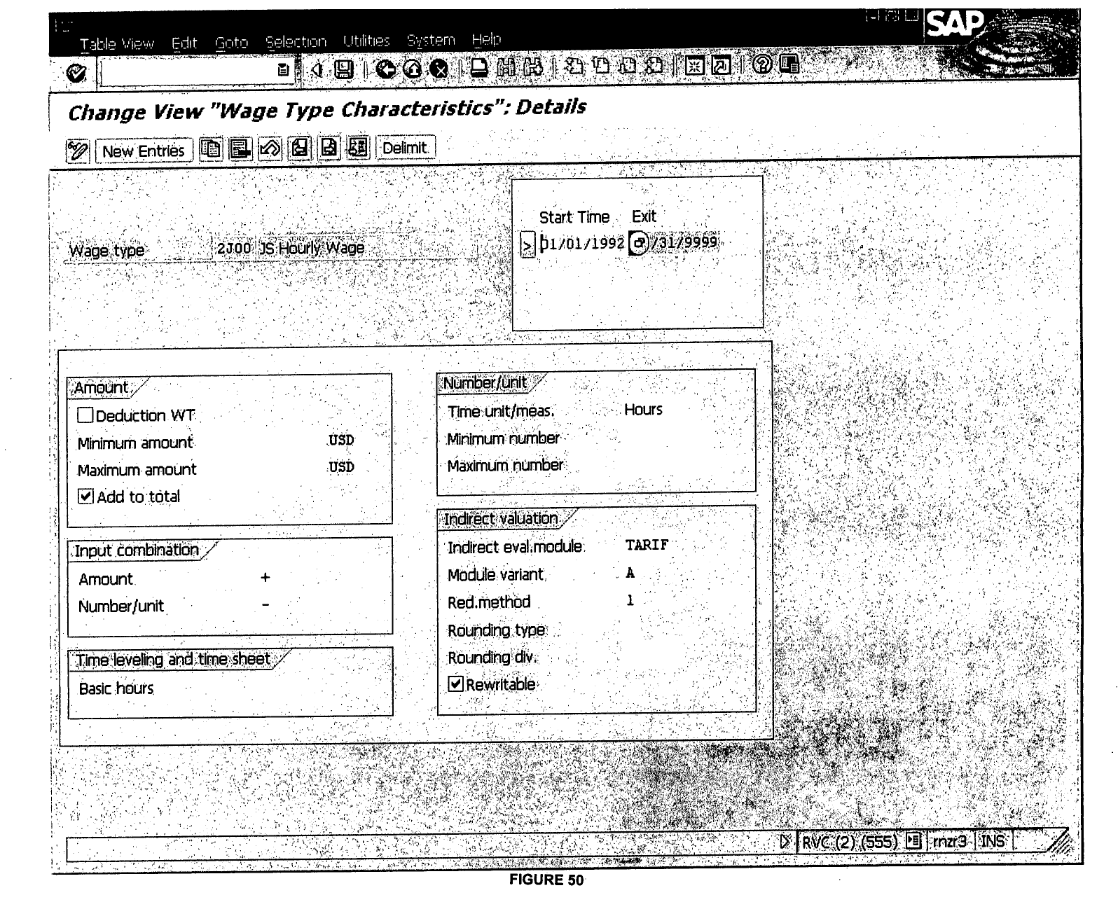

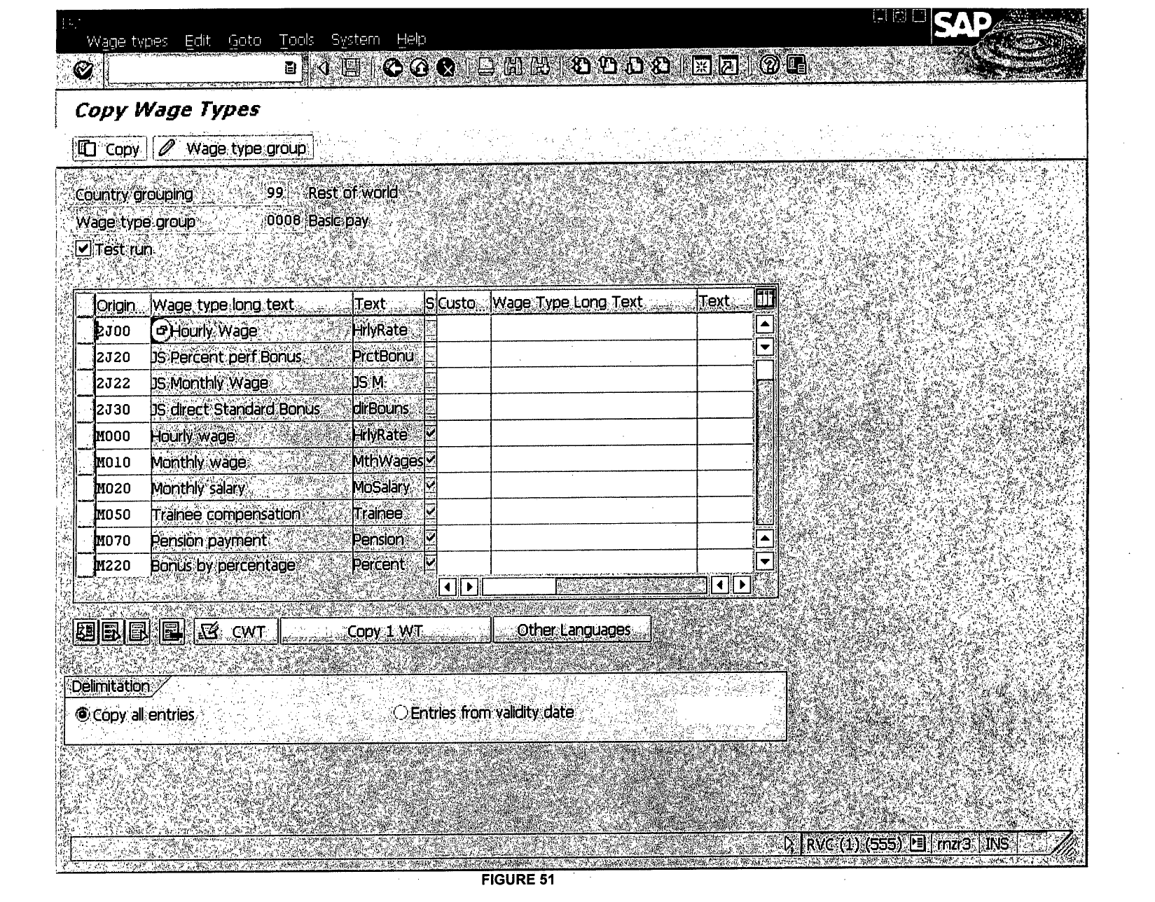

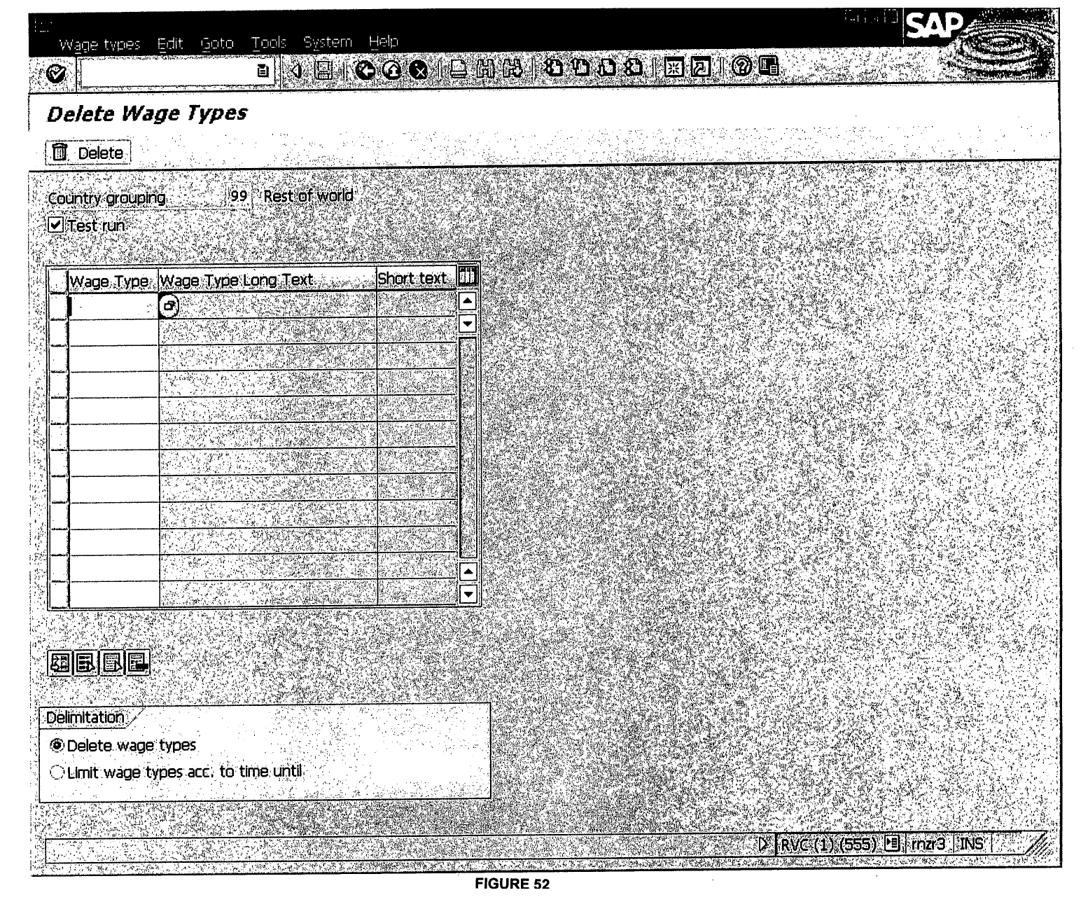

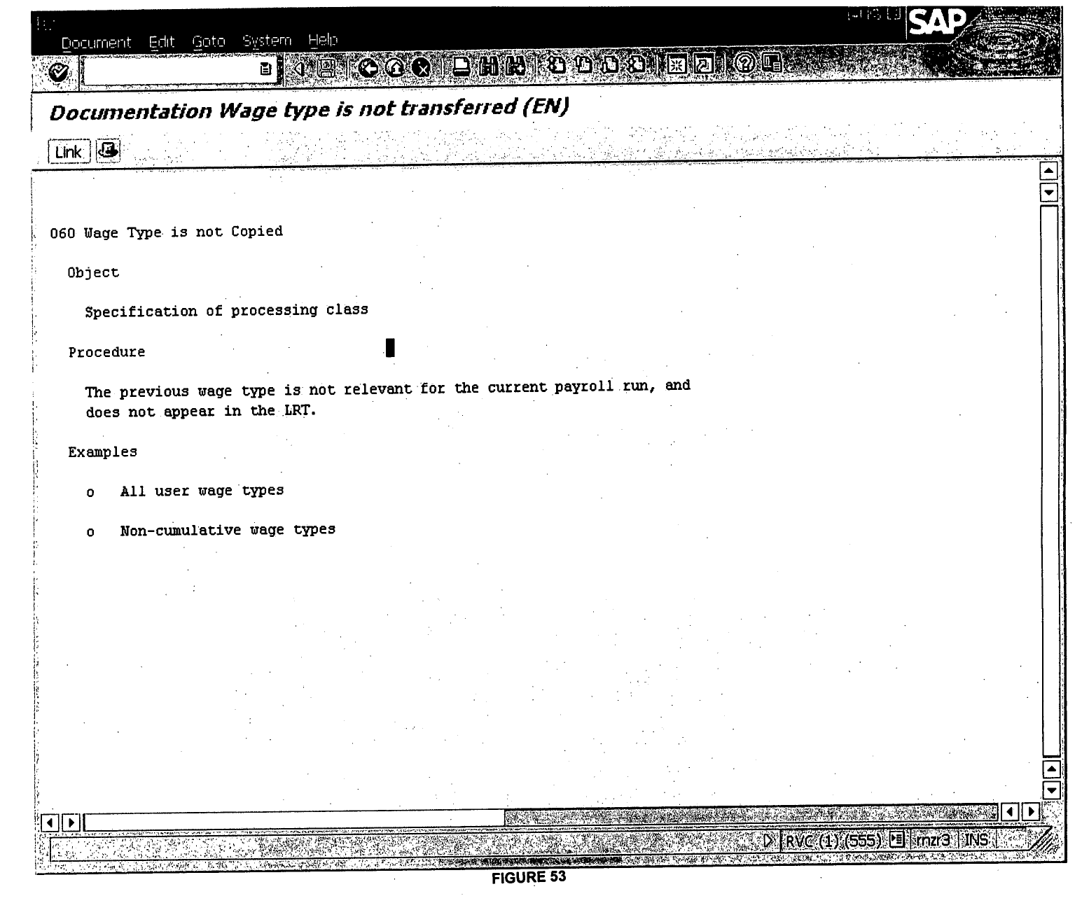

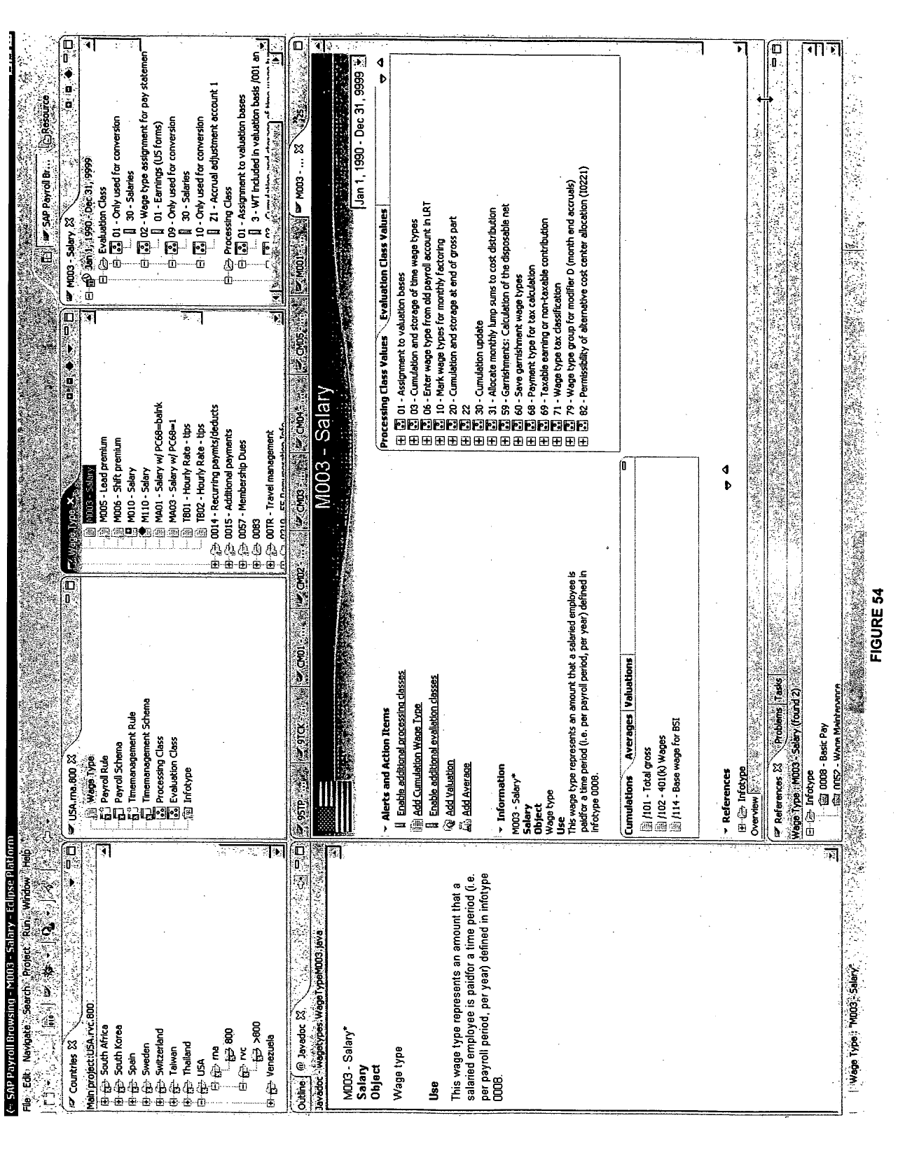

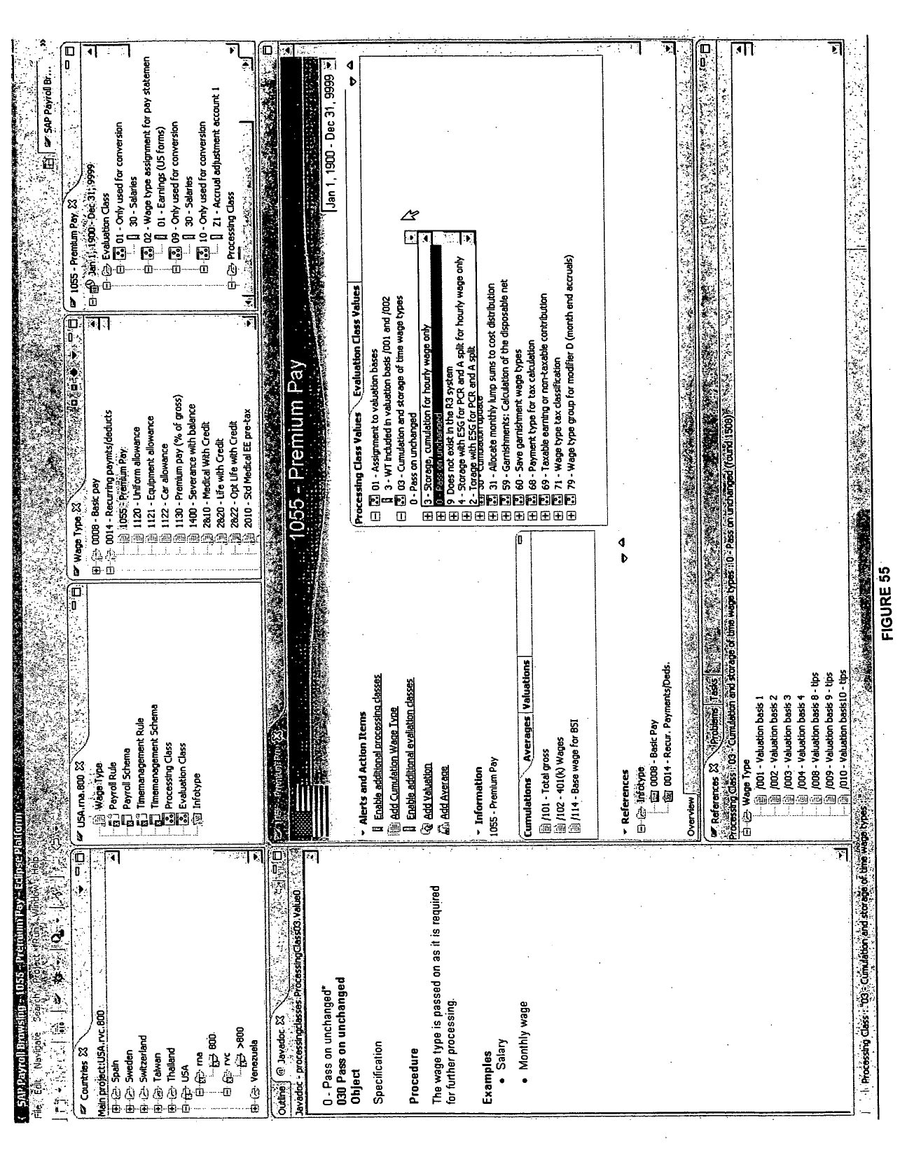

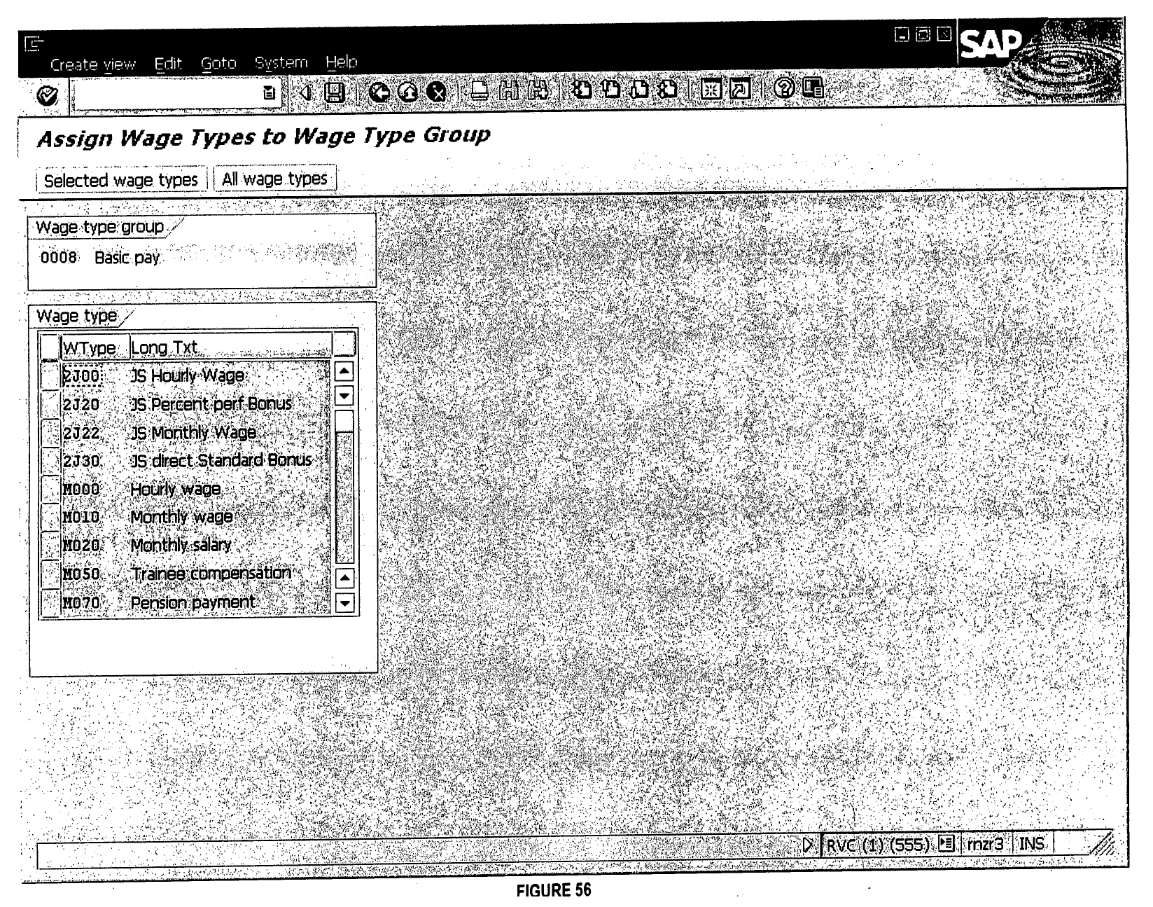

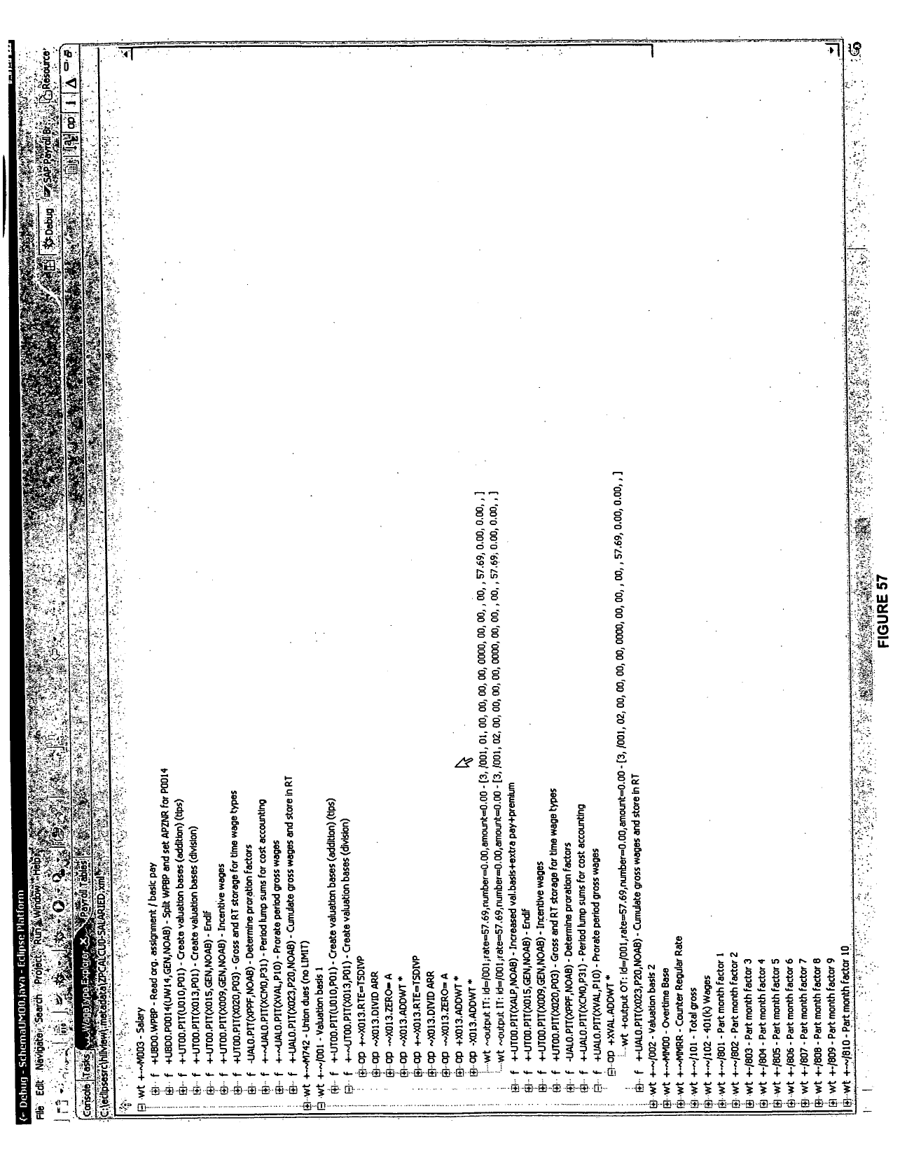

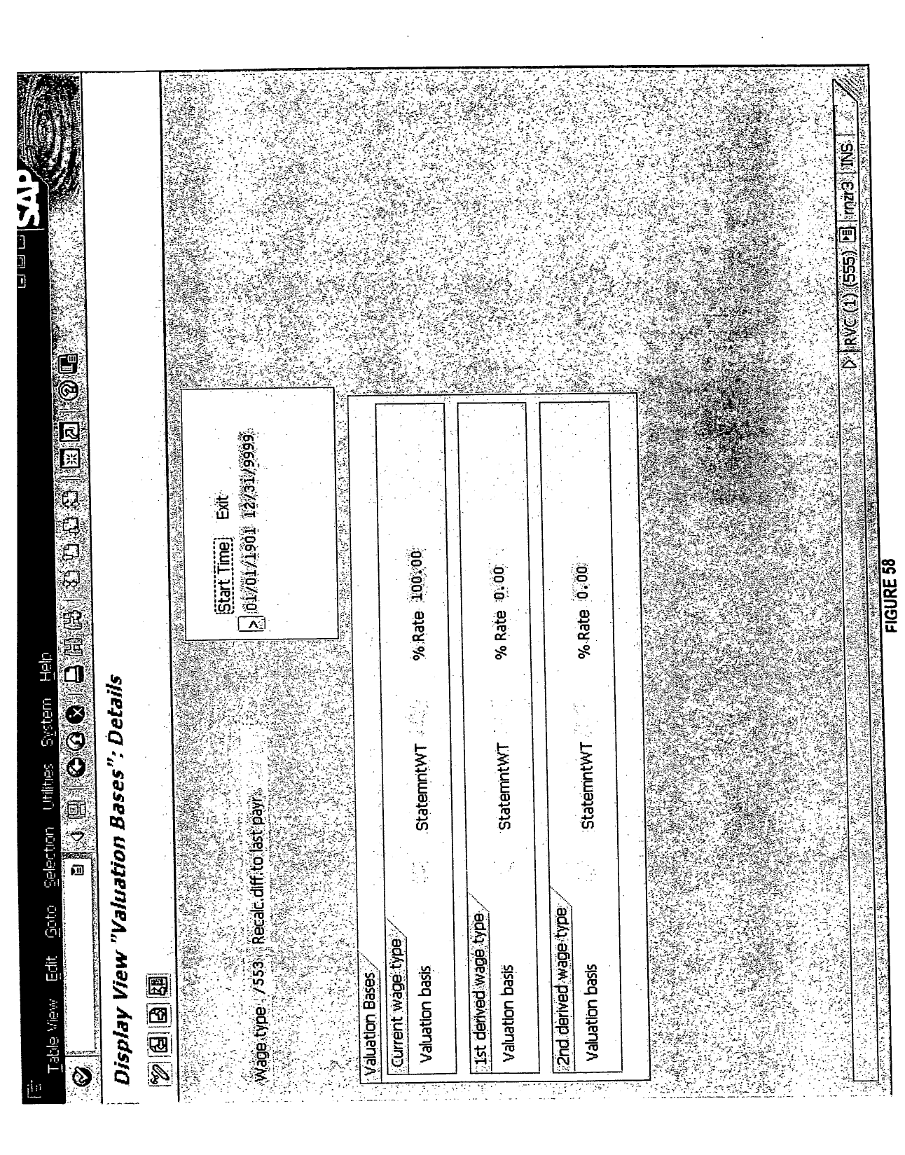

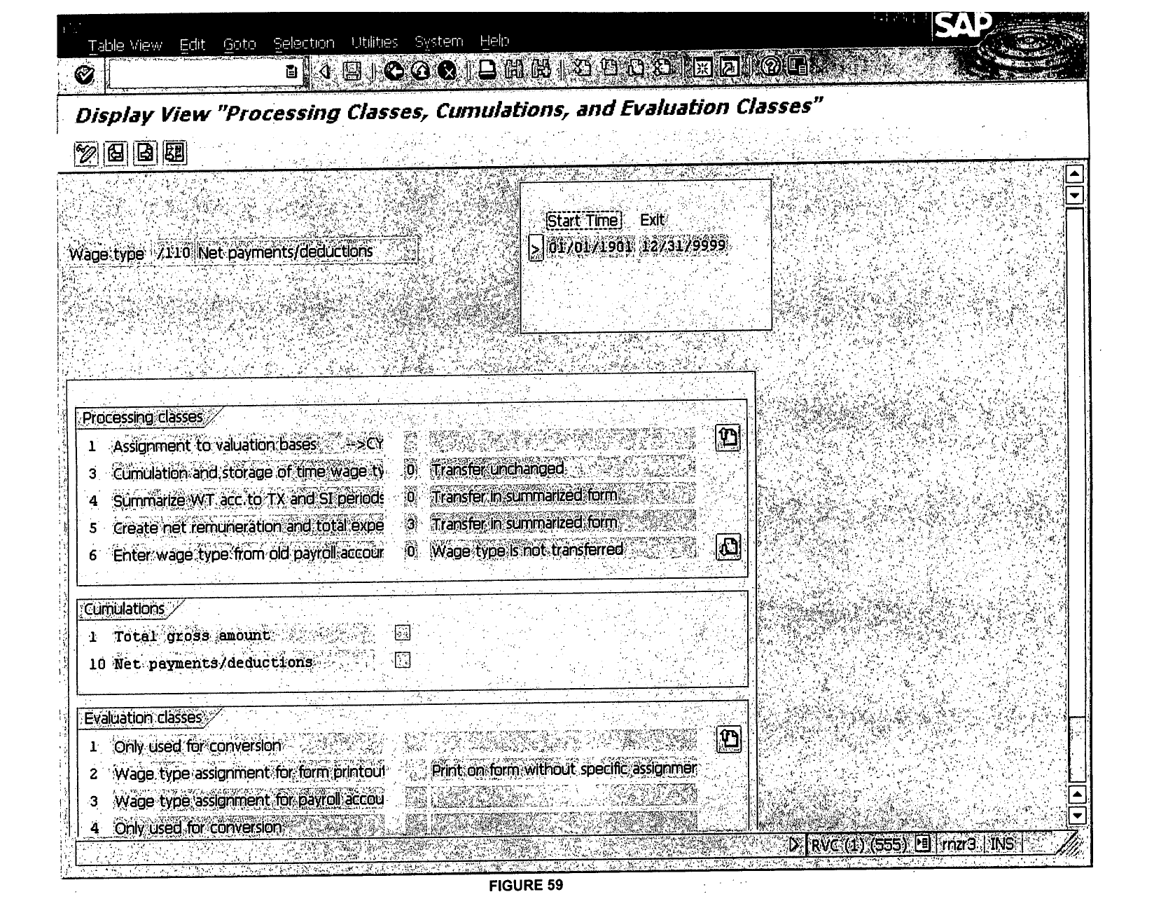

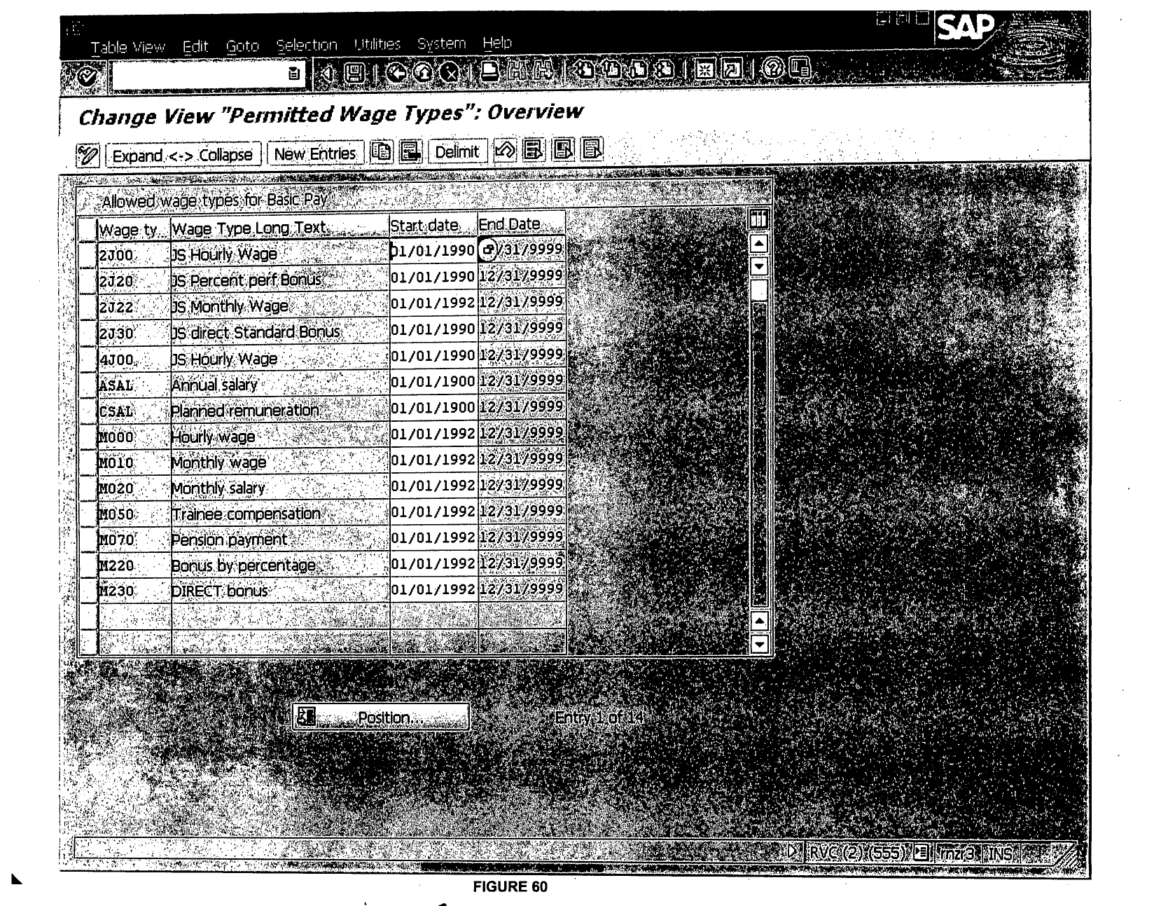

FIGS. 17 to 60 illustrate exemplary user interfaces consistent with the invention for enabling a user to process a model representing a business application, as described above with respect to FIGS. 1 to 16.

Consistent with methods and systems of the invention, a user interface displaying all the relevant information on one graphical and productive screen may be used. As shown in FIGS. 17 to 60, user interfaces consistent with the invention may enable a user to easily navigate within an object-oriented structure from one object to another. The user interface may provide an instant visual alert of a potential problem, for example, with a source code. The user interface may also provide an intelligent code assistance and wizards. For example, all the references to a selected object, such as a schema or a rule, may be instantly displayed facilitating an instant dependency analysis. In another example, a user interface may have superior error detection and reporting capabilities, such as instantly reporting errors or enabling a user to find an exact error location just after one click.

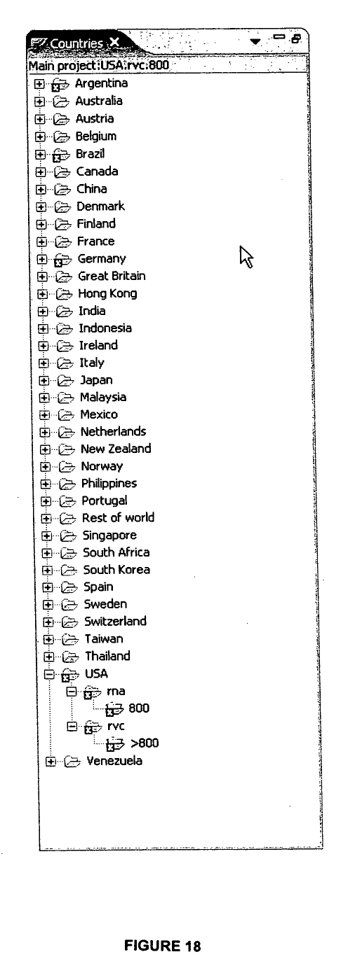

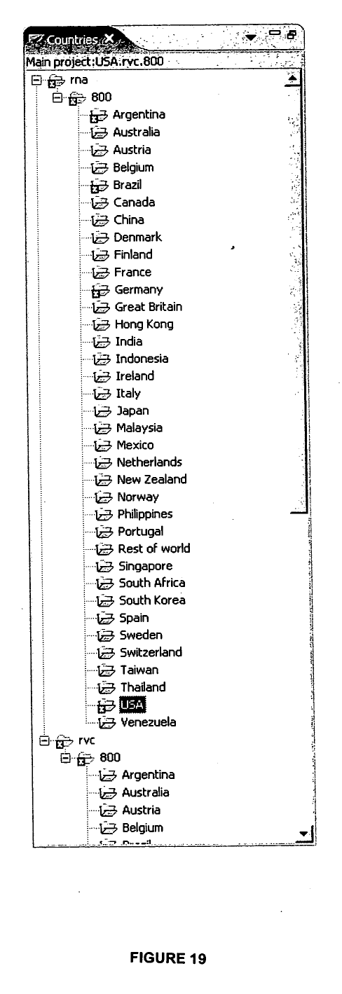

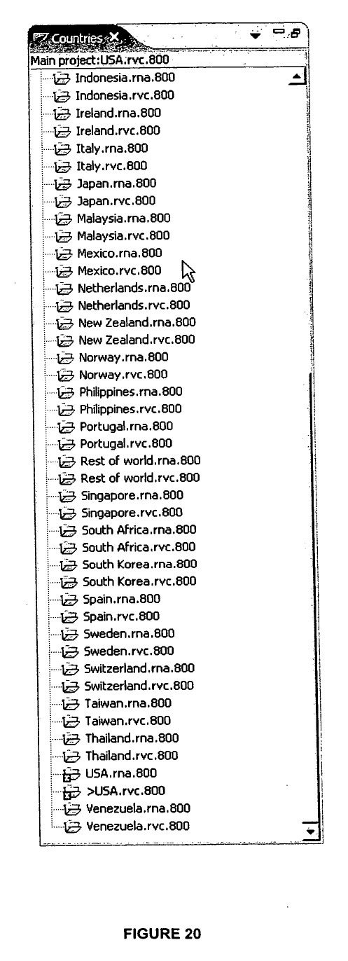

Consistent with methods and systems of the invention, a user interface shown in FIG. 17 illustrates auto-complete capabilities in an Integrated Configuration Editor (ICE) environment. As shown in FIG. 17, the user interface may list all the business objects and provides documentation for each of them. The user interfaces may depict grouping of the projects in ICE environment. For example, FIG. 18 depicts grouping of the projects defined by a country, and FIGS. 19 and 20 depict grouping of the projects defined by a system and a client, respectively, which has the least possible amount of attributes allowing to enforce uniqueness for all managed objects within a project. For example, using three attributes as the minimum set of attributes to define uniqueness, as shown in FIG. 19, may allow the system to rearrange attributes and build hierarchies with better workspace organization. The user interface shown in FIG. 20 may depict a linear project layout when all key attributes are shown in a project name. A little block with a cross inside appearing next to a project type may indicate an existing potential problem or an error. For example, a block next to Germany on FIG. 18, may indicate that an error in object “Germany” exists.

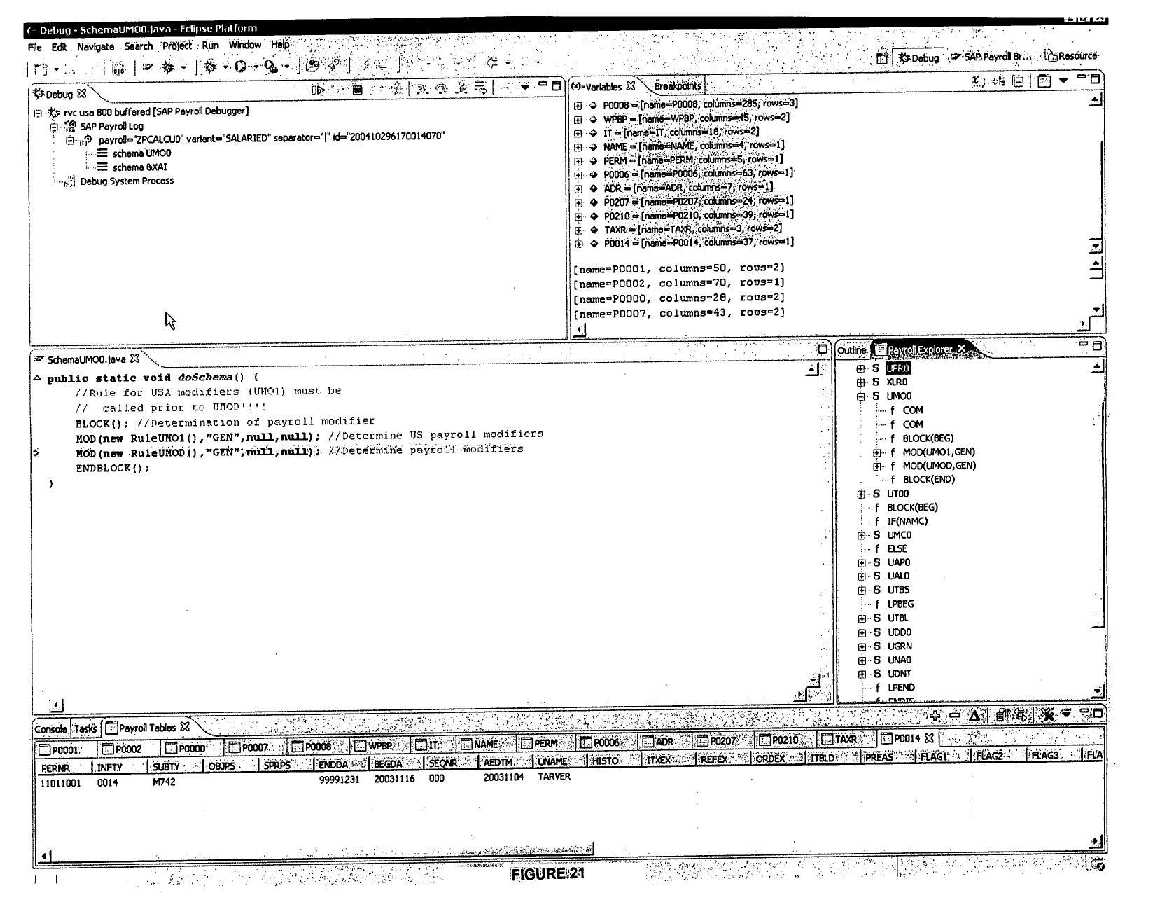

Consistent with methods and systems of the invention, a user interface shown in FIG. 21 may depict offline debugger or log replay. Having an ability to see this screen may allow a user to look at a dynamic and static views of payroll tables, full view of payroll steps, a source code displayed at a current execution point, and debugging controls.

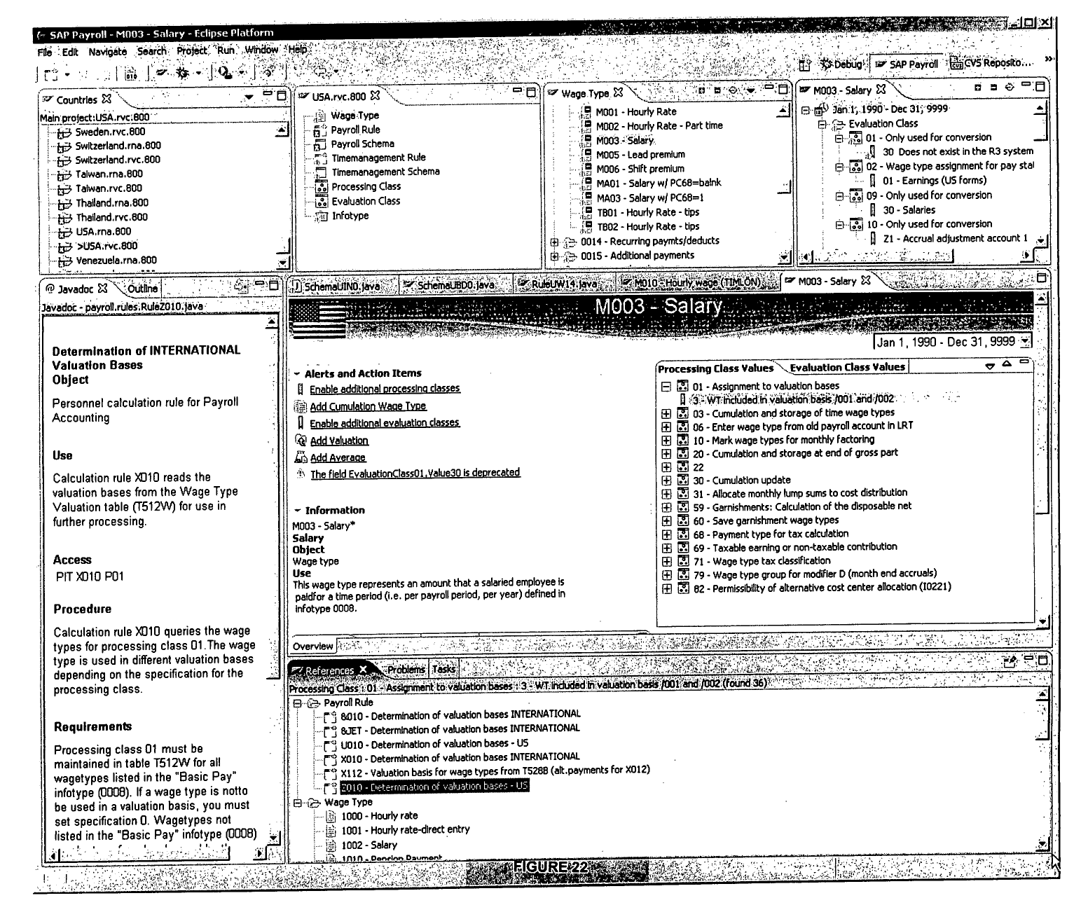

Consistent with methods and systems of the invention, a user interface shown in FIG. 22 may depict inter object relationships within a project. For example, a user highlighting processing class with value M003, such as salary wage type, may result in displaying different rules referenced to that wage type.

### XV. Conclusion

Accordingly, as disclosed, systems and methods are provided for analyzing a business application's data, operations, and relationships and creating a corresponding object oriented programming (OOP) object model, comprising OOP objects, functions, and operators corresponding to the business application entities, and various uses involving the OOP model for improving the business application. The foregoing description of possible implementations consistent with the present invention does not represent a comprehensive list of all such implementations or all variations of the implementations described. The description of only some implementations should not be construed as an intent to exclude other implementations. One of ordinary skill in the art will understand how to implement the invention in the appended claims in may other ways, using equivalents and alternatives that do not depart from the scope of the following claims.

The systems and methods disclosed herein may be embodied in various forms including, for example, a data processor, such as a computer that also includes a database. Moreover, the above-noted features and other aspects and principles of the present invention may be implemented in various environments. Such environments and related applications may be specially constructed for performing the various processes and operations according to the invention or they may include a general purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Systems and methods consistent with the present invention also include computer readable media that include program instruction or code for performing various computer-implemented operations based on the methods and processes of the invention. The media and program instructions may be those specially designed and constructed for the purposes of the invention, or they may be of the kind well known and available to those having skill in the computer software arts. Examples of program instructions include, for example, machine code, such as produced by a compiler, and files containing a high level code that can be executed by the computer using an interpreter.

What is claimed is:

1. A method of modeling a business application composed in a first programming format, comprising:
receiving logic entities of the business application;
generating, based on the received logic entities, a model representing the business application in a second programming format;
processing the generated model; and
regenerating, based on the processed model, the business application in the first programming format.

2. The method of claim 1, wherein the received logic entities represent table-based data structures of the business application.

3. The method of claim 2, wherein the table-based data structures include at least one of configuration data or processing rules of the business application.

4. The method of claim 1, wherein the second programming format is an object-oriented programming format, and wherein generating the model further includes:
generating an object-oriented model representing the business application.

5. The method of claim 4, wherein the object-oriented programming format is a Java programming format.

6. The method of claim 1, wherein processing the generated model further includes:
modifying the generated model; and
wherein the regenerated business application reflects the modifications made to the generated model.

7. The method of claim 1, wherein the second programming format is an object-oriented programming format, and wherein processing the generated model further includes:
applying an object-oriented processing tool to the generated model.

8. The method of claim 7, further comprising:
correcting an error detected by the object-oriented processing tool.

9. The method of claim 1, further comprising:
transmitting the regenerated business application to a target system.

10. The method of claim 1, wherein generating the model further comprises:
generating the model based on a set of transformation rules.

11. The method of claim 1, wherein processing the generated model further comprises:
creating a new logical entity in the second programming format.

12. The method of claim 1, wherein processing the generated model further comprises:
displaying a logical entity in the second programming format.

13. The method of claim 1, wherein processing the generated model further comprises:
modifying a logical entity in the second programming format.

14. The method of claim 1, wherein the business application is an SAP R/3 business application.

15. A method of translating a business application composed in a first programming format into a model composed in a second programming format, comprising:
receiving a plurality of table-based data structures of the business application, wherein each table-based data structure includes attributes of the data stored therein;
identifying attributes that are common to each of the plurality of table-based data structures;
selecting a minimum set of common attributes that allow unique definition of each of the plurality of table-based data structures;
using the selected minimum set of common attributes to define one or more translational data structures; and
generating the model based on the defined translational data structures.

16. The method of claim 15 wherein the defined translational data structures include at least one translational data structure that respectively corresponds to a project, an object, and an object instance.

17. The method of claim 15, wherein the second programming format is an object-oriented programming format.

18. A method for modeling a business application, comprising:
identifying a table-based data structure in the business application;
defining a transformation rule for converting the table-based data structure into an object-oriented structure, wherein the object-oriented structure reflects a relationship defined by the table-based data structure;
converting the table-based data structure into the object-oriented structure based upon the transformation rule; and
expressing the object-oriented structure as an object-oriented programming construct that models the business application.

19. The method of claim 18, wherein the business application is a payroll business application, the table-based data structure reflects a wage type, and the object-oriented structure is a Java class structure.

20. The method of claim 18, wherein the method further includes:
presenting the object-oriented programming construct to a user.
